(19) United States
(12) Patent Application Publication
(10) Pub. No.: US 2026/0289531 A1
(43) Pub. Date: Sep. 24, 2026

(54) SYSTEM

(71) Applicant: SoftBank Group Corp., Tokyo (JP)

(72) Inventor: Kazuya MORITA, Tokyo (JP)

(73) Assignee: SoftBank Group Corp., Tokyo (JP)

(21) Appl. No.: 19/562,820

(22) Filed: Mar. 11, 2026

(30) Foreign Application Priority Data
Mar. 19, 2025 (JP) 2025-044938

(51) Int. Cl. G06Q 10/42; G06N 3/0475

(52) U.S. Cl. CPC G06Q 10/42; G06N 3/0475

(57) ABSTRACT

A system includes a processor that is configured to: receive, via an information processing device, user input including preferences and desired characteristics; transmit the received user input to an information storage device by using a communication device; generate a prompt for instructing a generative AI model to perform an analysis based on information accumulated in the information storage device; and input the generated prompt into the generative AI model to cause the generative AI model to perform the analysis.

### CROSS-REFERENCE TO RELATED APPLICATION

This application is based on and claims priority under 35 USC 119 from Japanese Patent Application No. 2025-044938 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional matching and recommendation systems for users' personal or professional preferences are often limited to static rule-based filtering or simple keyword matching. Such systems typically rely on predetermined matching criteria and fixed algorithms that cannot fully capture complex user preferences or dynamically adapt to diverse and evolving user needs. Furthermore, when user information is merely stored without being effectively leveraged by advanced analytical techniques, the system cannot provide sufficiently accurate, flexible, or context-aware suggestions. There is therefore a need for a system that can collect user-specific information through an information processing device, store the information in an information storage device, and utilize a generative AI model, which employs machine learning algorithms, to perform advanced analysis and identify targets that better match user preferences.

### SUMMARY

To solve the above-described problem, the present invention provides a system comprising a processor, wherein the processor is configured to receive, via an information processing device, user input including preferences and desired characteristics, transmit the received user input to an information storage device by using a communication device, generate a prompt for instructing a generative AI model to perform an analysis based on information accumulated in the information storage device, and input the generated prompt into the generative AI model to cause the generative AI model to perform the analysis. In one embodiment, the processor is configured to cause the user input to include age, occupation, hobby, and place of residence, thereby enabling the system to acquire detailed user attributes and preferences. In another embodiment, the processor is configured to cause the generative AI model to use a machine learning algorithm to perform the analysis based on the prompt and to identify a target that matches a preference of the user, whereby more precise and adaptive matching and recommendations can be provided compared to conventional rule-based systems.

The term “processor” refers to one or more hardware computing units, such as a central processing unit (CPU), a microprocessor, or a system-on-chip (SoC), and may further encompass associated circuitry and components that execute instructions to perform the functions described for the system.

The term “information processing device” refers to a user-operated terminal device, such as a personal computer, smartphone, tablet, or other electronic apparatus, that provides a user interface for inputting information and communicating with the processor.

The term “user input” refers to information that is explicitly provided by a user through an information processing device, including but not limited to textual entries, selections from predefined options, or other forms of data indicating the user's preferences and desired characteristics.

The term “preferences” refers to indications of likes, interests, or desired conditions specified by the user, which the system uses as criteria for analysis or matching.

The term “desired characteristics” refers to attributes or properties that a user wishes a target, such as a person, object, or service, to possess, and that are specified as part of the user input. The term “communication device” refers to hardware and associated software components that enable data transmission between the processor, the information processing device, and the information storage device, including network interfaces, modems, wireless communication modules, and similar communication means.

The term “information storage device” refers to a storage medium or storage system, such as a hard disk drive, solid-state drive, database server, or cloud storage, that is configured to store user input and other related data in an accumulated manner.

The term “accumulated information” refers to information, including user input and related data, that has been stored over time in the information storage device and is available to be referenced or analyzed by the system.

The term “prompt” refers to data, typically in the form of a text string or structured instruction, that is generated by the processor and provided as input to a generative AI model in order to instruct the generative AI model to perform a specified analysis.

The term “generative AI model” refers to a machine learning-based model, such as a neural network, that is configured to generate outputs, including analytical results, in response to input data such as prompts, and that can learn patterns from training data.

The term “machine learning algorithm” refers to a computational method or set of methods used by the generative AI model to learn from data, update internal parameters, and perform analysis or predictions based on input information.

The term “analysis” refers to processing performed by the generative AI model in response to a prompt, including operations such as pattern recognition, inference, matching, or evaluation, to derive information useful for identifying a target matching the user's preferences.

The term “target” refers to an entity, such as a person, item, service, or content, that is identified by the system as being relevant to or matching the user's preferences and desired characteristics.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

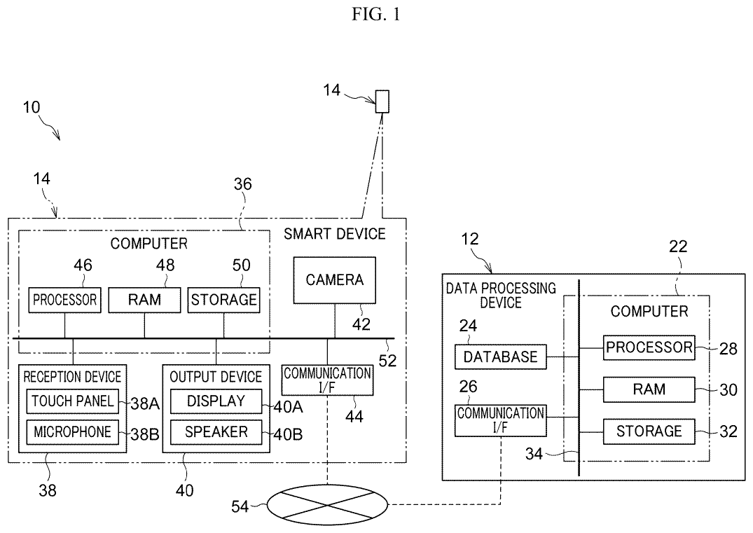

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

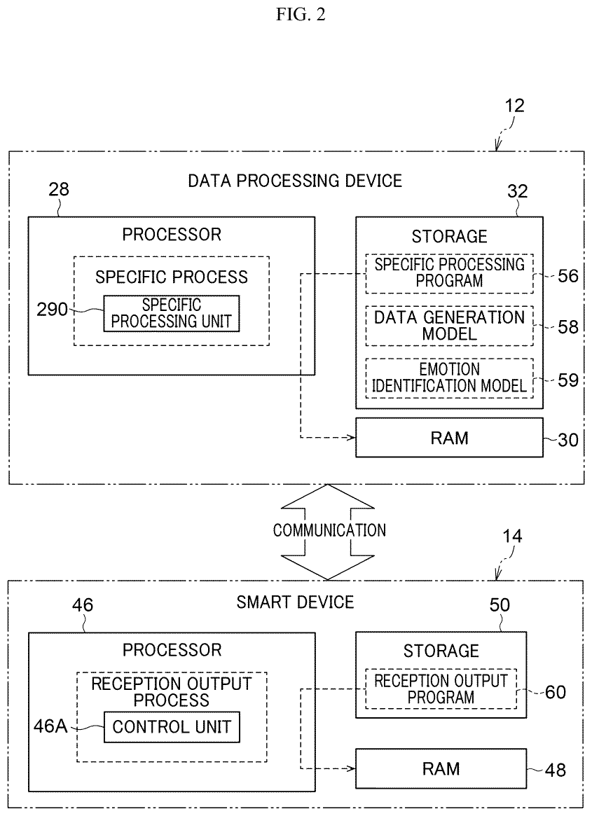

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional recommendation systems that attempt to match users with suitable partners typically rely on fixed rule sets, simple statistical ranking, or manually tuned similarity measures over structured profile data. Such systems are limited in their ability to capture nuanced user intent, to flexibly interpret heterogeneous input attributes, and to adapt to changes in user behavior over time. As a result, the systems often generate recommendations that are either too generic or misaligned with a user's true preferences, leading to low engagement and requiring repeated manual search and filtering by the user. Moreover, in many existing architectures, the processing pipeline from user input to recommendation output is fragmented: user attributes are collected and stored, and a separate matching engine performs similarity computation, while any natural-language description provided by the user is either ignored or only superficially used. Generative AI models are sometimes employed merely as an add-on text generator, not as an integrated component that jointly interprets natural-language prompts and structured feature data for ranking and selection. This fragmented processing causes inefficiencies, increases latency, and fails to fully utilize the representational capabilities of generative AI models.

Further, conventional systems do not systematically use user behavior history (such as viewed candidates, selected candidates, or messaging actions) to dynamically refine both the model input and the prompt sentence supplied to the generative AI model. Without such iterative refinement, the system cannot effectively learn from interaction logs to improve subsequent recommendations, and often requires extensive manual configuration or separate offline model retraining. This leads to a technical problem in computer technology: the absence of an integrated, machine-driven mechanism that transforms raw user inputs and behavior logs into optimized prompt sentences and feature representations, and that uses these optimized inputs in a unified pipeline to generate, filter, and update recommendation results with reduced computational waste and improved relevance.

Accordingly, there is a need for a computer-implemented system and method that: (i) converts user-entered attributes and preference information into both numerical and text-based features; (ii) constructs a prompt sentence in natural language conditioned on these features; (iii) inputs the prompt sentence and associated feature representations into a generative AI model to perform similarity-based analysis; (iv) applies rule-based filtering and score correction in a server-side pipeline; and (v) iteratively updates the prompt sentence and feature weighting using behavior history information, thereby improving the efficiency, adaptability, and technical performance of the recommendation process executed by the computing infrastructure.

The specific processing by the specific processing unit 290 of the data processing device 12 in Example 1 is realized by the following means.

The present invention provides a server comprising a processor configured to receive, via a communication device, attribute conditions and preference information input by a user through a terminal device, to store user information including the attribute conditions and the preference information in an information storage device including a relational database, to acquire the user information together with other user information accumulated in the information storage device, to perform preprocessing on the acquired user information and the other user information by a data conversion unit so as to generate numerical feature data and character string feature data, to generate a prompt sentence including a natural language expression corresponding to the attribute conditions and the preference information and configured based on the numerical feature data and the character string feature data, to input the prompt sentence and the feature data into a generative AI model so as to cause the generative AI model to execute machine learning processing including similarity calculation between feature vectors to identify target candidates suitable for the user's preference and to output evaluation information for the target candidates, to rank the target candidates based on the evaluation information so as to generate recommendation result data to be presented to the user, to provide the recommendation result data to the terminal device for display, to acquire behavior history information of the user from the information storage device, to update components of the prompt sentence and weighting of the numerical feature data and the character string feature data based on the behavior history information, and to perform re-analysis by the generative AI model using the updated prompt sentence and updated feature data, while executing, on the target candidates and the evaluation information output from the generative AI model, filtering processing and score correction processing based on a rule set including a location condition, a contact history condition, and an exclusion condition, so as to finally select target candidates for inclusion in the recommendation result data. This enables an integrated computer-implemented recommendation pipeline in which the server dynamically transforms user inputs and interaction logs into optimized prompt sentences and feature representations for a generative AI model, thereby improving the technical performance of matching and ranking operations, reducing unnecessary computation, and adaptively increasing the relevance and quality of recommendation results generated by the computing system.

The term “processor” refers to a hardware or virtual computation unit, such as a central processing unit or a computation core in a computing environment, that executes machine-readable instructions to control operations of a server device, a terminal device, and associated components.

The term “terminal device” refers to an information processing apparatus operated by a user, such as a general-purpose computing device or a portable electronic device, that provides a user interface for inputting information and for displaying information received from a server device.

The term “display control unit” refers to a functional component implemented by hardware, software, or a combination thereof in the terminal device, which generates and manages graphical user interfaces and screen elements presented to the user.

The term “screen interface” refers to a graphical or textual presentation on a display of the terminal device that enables the user to input information by means of interactive components such as text fields, selection boxes, buttons, and other input controls.

The term “user” refers to an individual or an entity that interacts with the system via the terminal device in order to input information, receive recommendation results, and optionally initiate communication with other users.

The term “attribute conditions” refers to structured parameters describing desired properties of a target candidate, including, for example, demographic characteristics, occupational categories, interest categories, or geographical conditions, which can be represented as discrete or continuous data.

The term “preference information” refers to data indicating subjective likes, dislikes, priorities, or constraints specified by the user, including qualitative or quantitative expressions of desired traits, behaviors, or contexts for the target candidate.

The term “desired target” refers to an entity, such as another user profile or a candidate record in a database, that is to be evaluated and selected by the system according to the attribute conditions and the preference information of the user.

The term “communication device” refers to a hardware and software communication subsystem, including network interfaces and communication protocols, that enables data exchange between the terminal device, the server device, and the information storage device over a communication network.

The term “encrypted communication scheme” refers to a communication protocol employing cryptographic techniques, such as transport layer security or other encryption mechanisms, for providing confidentiality and integrity of data transmitted between the terminal device and the server device.

The term “server device” refers to a computing apparatus, which may be a physical server, a virtual server, or a distributed computing node, configured to execute backend application logic, manage data processing, interact with a database, and communicate with one or more terminal devices.

The term “information storage device” refers to one or more storage subsystems, including volatile or non-volatile memory and external or internal storage units, that retain user information, behavior history information, and other data used by the server device.

The term “relational database” refers to a data management system that stores data in one or more logically related tables and supports structured query operations, transactions, and constraints according to a relational data model.

The term “user information” refers to data associated with a user, including input attribute conditions, preference information, profile data, and any other structured or unstructured information stored in the information storage device.

The term “other user information” refers to user-related data for users other than the current user, including their profile information, preferences, and any data used to form potential target candidates for recommendation.

The term “data conversion unit” refers to a functional component, implemented by software, hardware, or a combination thereof, that performs operations such as normalization, encoding, vectorization, and other transformation processes on raw data to generate feature representations.

The term “preprocessing” refers to a sequence of data manipulation operations performed prior to model analysis, including cleaning, normalization, feature extraction, feature encoding, and aggregation of raw input data into consistent numerical or textual representations.

The term “numerical feature data” refers to data representing characteristics of users or candidates in a numeric format, such as scalar values, vectors, or matrices, suitable for mathematical operations in a machine learning process.

The term “character string feature data” refers to data representing characteristics of users or candidates in a text-based format, such as strings or token sequences, including natural language descriptions, labels, and encoded textual features.

The term “prompt sentence” refers to a natural language text sequence generated by the server device, which encodes at least the attribute conditions and the preference information, and which is supplied as an input instruction or context to a generative AI model.

The term “natural language expression” refers to a human-readable textual representation, in a natural language, of conditions, preferences, or constraints, which can be processed by the generative AI model as part of the prompt sentence.

The term “generative AI model” refers to a machine learning model, such as a neural network-based generative model, configured to process prompt sentences and feature data to produce outputs including predicted candidates, scores, or explanatory text, based on learned patterns.

The term “machine learning processing” refers to computational procedures executed by the generative AI model or other models, in which learned parameters are applied to input feature data and prompt sentences to infer outputs such as similarity scores, classifications, or rankings.

The term “feature vectors” refers to ordered sets of numerical components representing attributes or characteristics of users or candidates, which can be used in vector operations such as similarity calculation or transformation in machine learning algorithms. The term “similarity calculation” refers to a mathematical operation that computes a measure of similarity or distance between two or more feature vectors, using methods such as inner product, cosine similarity, or other distance metrics.

The term “target candidates” refers to a set of candidate entities, including but not limited to other user profiles, that are evaluated by the system as potential matches or recommendations for the user based on the user's attribute conditions and preference information.

The term “evaluation information” refers to data output by the generative AI model or subsequent processing, such as scores, rankings, probabilities, or explanatory descriptors, that quantify or describe the suitability of each target candidate relative to the user.

The term “recommendation result data” refers to structured output data generated by the server device, including selected target candidates, their associated evaluation information, and any descriptive information, prepared for presentation to the user via the terminal device. The term “behavior history information” refers to data representing past interactions of the user with the system, including viewed candidates, selected or rejected candidates, sent or received messages, and other operational logs that reflect user behavior over time. The term “weighting of feature data” refers to the assignment or adjustment of numerical weights to components of numerical feature data or character string feature data, influencing their relative impact on similarity calculations or other machine learning processes.

The term “re-analysis” refers to a subsequent execution of machine learning processing by the generative AI model, after updating the prompt sentence and feature data, in order to recompute evaluation information and recommendation result data.

The term “rule set” refers to a collection of predetermined conditions and logical criteria, implemented in software or hardware, that are applied by the server device for filtering, modifying, or constraining target candidates and their evaluation information.

The term “location condition” refers to a rule or constraint based on geographical attributes, such as residence area, region, or proximity, used to filter or prioritize target candidates. The term “contact history condition” refers to a rule or constraint based on historical communication or interaction between users, such as prior messaging, connection requests, or blocks, used to filter or adjust evaluation information for target candidates.

The term “exclusion condition” refers to a rule that specifies criteria for excluding certain target candidates from recommendation results, based on predefined factors such as incompatibility, user-specified exclusions, or system-level restrictions.

The term “filtering process” refers to an operation that removes or flags target candidates from a candidate set based on a rule set, so that only candidates satisfying specified conditions remain eligible for recommendation.

The term “score correction process” refers to an operation that modifies evaluation information, such as candidate scores or rankings, based on additional rules, constraints, or behavioral signals, to generate adjusted scores for final selection.

The term “finally select” refers to a determination performed by the server device, after applying filtering and score correction processes, to identify a subset of target candidates to be included in the recommendation result data presented to the user.

In one embodiment, a server cooperates with one or more terminals operated by users to execute a recommendation process using a generative AI model. The server includes at least one processor, a memory, a network interface, and an information storage device implemented as a relational database. The terminal includes at least one processor, a display, input devices, and a network interface, and executes a web browser or a dedicated client application.

The terminal provides a screen interface. The terminal uses a display control unit implemented by a browser engine and client-side scripts to render a graphical user interface. The terminal displays input components such as text boxes, drop-down lists, check boxes, and buttons that allow the user to enter attribute conditions and preference information. The user operates the terminal to input desired attributes of target candidates, for example age range, professional field, categories of interests, and geographical region. The user further inputs free-form preference information, such as descriptions of desired lifestyles or activities.

The terminal transmits user information to the server. The terminal converts the input attribute conditions and preference information into structured data in a predetermined format and sends the structured data to the server via an encrypted communication scheme. The terminal employs a transport-layer security protocol over a packet-switched network, and the terminal's network interface encapsulates the structured data in request messages directed to an application endpoint on the server.

The server receives and stores user information. The server parses the structured data at an application layer using server-side software, such as a web framework executing on an operating system. The server performs schema validation and normalizes the attribute conditions and preference information. For example, the server maps free-text occupational labels to internal category identifiers, and converts age ranges into numeric bounds. The server writes the normalized user information into relational tables in the information storage device, such as a user table, a preference table, and a candidate table, using a database driver and structured query language statements. The server thereby maintains a collection of user information and other user information in a consistent schema that supports efficient indexed querying.

The server generates feature data from the stored information. The server executes a data conversion unit implemented by software components in the memory. The data conversion unit reads attribute conditions and preference information from the relational database and converts them into numerical feature data and character string feature data. The server, via the data conversion unit, encodes categorical attributes such as occupation and interest categories into one-hot vectors or embedding vectors, scales numeric values such as age and distance, and tokenizes text fields such as self-introductions and free-form preferences into sequences of tokens. The server may use libraries such as data frame libraries, numerical computation libraries, and tokenization libraries to perform these transformations. As a result, the server produces feature vectors that are directly consumable by a neural network model. The server constructs a prompt sentence for a generative AI model. The server generates a prompt sentence as a natural language text sequence that expresses the user's attribute conditions and preference information in a compact and machine-consumable form. The server may generate, for example, the following prompt sentence:

“I am looking for a partner in their thirties who works in the IT industry and enjoys outdoor activities.”

The server may also generate another example prompt sentence:

“Recommend professionals in a similar age range, working in the technology sector, who like hiking, camping, and other outdoor hobbies, and who live in or near a specified region.” The server constructs the prompt sentence using a template mechanism that inserts normalized attributes and preferences into fixed language patterns and may augment the sentence with additional instructions specifying ranking criteria or constraints. The server then associates the prompt sentence with the previously generated numerical feature data and character string feature data. This joint construction of prompt and feature data forms a structured input package for a generative AI model executing either on the server or on a connected computation resource.

The server executes a generative AI model. In one embodiment, the server loads a generative AI model implemented as a transformer-based neural network, which includes an embedding layer, a plurality of self-attention layers, feed-forward layers, and an output layer configured to produce token sequences and/or numerical scores. The server may implement the generative AI model using a machine learning framework that executes on the server's hardware, optionally leveraging a graphics processing unit for accelerated matrix operations. The server inputs the prompt sentence and feature vectors into the generative AI model. The server converts the prompt sentence into token identifiers using a vocabulary and an embedding matrix, resulting in a sequence of token embeddings. In one embodiment, the server augments the token sequence with additional feature embeddings derived from the numerical feature data and character string feature data, for example by concatenating or adding special feature tokens that encode age distributions, occupation categories, and interest intensity weights. The server passes these combined embeddings through the self-attention layers of the model, enabling the model to compute attention scores between tokens and feature representations. This process produces a contextual embedding that reflects the relationship between the user's stated preferences and potential candidate characteristics. The server configures the generative AI model to produce compatibility scores. Rather than simply generating natural language text, the server adapts the output layer to compute similarity metrics or ranking scores for candidate feature vectors. In one embodiment, the server represents each candidate in the database as a separate feature vector and uses a projection of the contextual embedding as a query vector in a similarity computation. The server calculates, for each candidate vector, a similarity score with respect to the query vector using, for example, a dot product or cosine similarity. The server thereby obtains evaluation information in the form of numerical scores that quantify how well each candidate matches the prompt sentence and the feature representation of the user.

The server improves the technical performance of similarity computation through this architecture. By embedding the user's structured attributes and free-form preferences into a single representation space and performing vectorized similarity calculations in the neural network, the server reduces the need for multiple separate matching engines and redundant database scans. The server performs similarity computations in parallel on batches of candidate vectors, leveraging optimized linear algebra operations, which results in improved processing speed and reduced computational overhead compared to ad hoc rule-based matching.

The server implements a learning procedure for the generative AI model. In a training phase, the server uses historical interaction data stored in the relational database as supervisory signals. The server collects pairs or triplets of user-candidate interactions labeled as positive (e.g., successful contact or long-term interaction) or negative (e.g., ignored or explicitly rejected). The server constructs training inputs consisting of prompt sentences and feature vectors and associates them with target labels or relative rankings. The server defines a loss function, such as a cross-entropy loss or a contrastive loss, that measures the discrepancy between model-predicted similarity scores and the historical outcomes. The server computes gradients of the loss function with respect to model parameters and updates the weights of the embedding matrices, attention layers, and output layers using an optimization algorithm such as stochastic gradient descent or a variant thereof. Through repeated training iterations, the server tunes the model to generate more discriminative embeddings, leading to improved recommendation accuracy and reduced error rates.

The server ranks and filters candidate results. After the generative AI model outputs raw evaluation information, the server applies a post-processing module that executes additional rule-based operations. The server uses a rule set that includes at least a location condition, a contact history condition, and an exclusion condition. For example, the server removes candidates located outside a specified geographical radius, excludes candidates with whom the user has blocked communication, and suppresses candidates that have been recently presented and rejected. The server also performs a score correction process, where the server adjusts similarity scores using factors such as recent interaction trends, recency weights, or diversity constraints. This combination of learned similarity scores and explicit rule-based modulation produces a final ranked list of candidates that both respects user constraints and maintains high relevance, thereby reducing the likelihood of technically inefficient or redundant recommendations.

The server updates prompt sentences and feature weights based on behavior history. The server periodically or in response to certain triggers retrieves behavior history information from the relational database, such as which candidates were viewed, which candidates elicited messages, and which were ignored. The server transforms this behavior history into statistical summaries, for example frequency counts of selected occupations or hobbies among positively engaged candidates. The server updates internal weighting coefficients applied to specific dimensions of the feature vectors, such as increasing the weight of outdoor activity-related features if the user repeatedly chooses candidates who list outdoor hobbies. The server also modifies the prompt sentence to reflect this refined preference pattern, for instance changing “enjoys outdoor activities” to “strongly prefers hiking and camping on weekends” when behavior indicates a more specific interest. This adaptive modification of prompt and feature weighting constitutes computer-level optimization that reduces search space and increases the probability that subsequent generative AI model runs will produce high-scoring candidates with fewer inference passes.

The terminal displays recommendation results. The terminal receives recommendation result data from the server, including the identifiers of selected target candidates, associated evaluation scores, and descriptive attributes. The terminal's display control unit renders the results as a list or grid of candidate cards. Each card may display age range, professional field, main hobbies, and a visual indicator of match score. The terminal can also display explanation text derived from the generative AI model or from rule-based annotations, such as “Recommended because this candidate is in your preferred age range, works in a similar industry, and frequently engages in outdoor hobbies.” This presentation structure assists users in understanding the basis of the system's suggested matches and encourages more informed interactions.

The user initiates interactions with recommended candidates. The user inspects candidate profiles on the terminal and may choose to send a message to a candidate. The terminal transmits message content to the server, which the server records in message tables and conversation tables in the database. The server then updates behavior history information to reflect the user's actions. These operation logs become part of the training and re-ranking data used in later re-analysis, thus closing a feedback loop in which the system continually refines internal models.

The server thereby implements more than mere automation of manual selection. The server uses specific data structures, including numerical feature vectors and token sequences, specific algorithms, including transformer-based attention mechanisms, similarity computations and gradient-based learning, and specific pipeline stages, including prompt construction, feature encoding, rule-based post-processing, and behavior-based adaptation. Through these technical measures, the server reduces database query overhead by precomputing and caching feature embeddings, shortens inference time by performing batch matrix operations on candidate vectors, and increases accuracy by learning non-linear interactions between multiple attributes that are not feasibly captured by manual rules. These improvements in speed, precision, and data management represent concrete enhancements to the functioning of the underlying computing system.

In another embodiment, the server executes the generative AI model as a service in a separate computation node connected over a network. The server in this case acts as an orchestrator that prepares prompt sentences and feature data, transmits them to the model service via an application programming interface, and receives evaluation information. The server may compress feature vectors before transmission and decompress returned scores, thereby reducing communication load. The server can also implement caching of model outputs keyed by hashed representations of the prompt sentence and feature data, reducing redundant invocations of the generative AI model when similar queries recur, which further improves throughput and latency in a multi-user environment.

In a further embodiment, the terminal may be implemented as a portable computing device equipped with local storage and processing capability sufficient to perform partial inference. The server can offload simple feature encoding steps to the terminal, reducing server-side computation and network traffic. The server then focuses on the more computationally intensive similarity calculations and ranking operations using more powerful hardware. This division of labor between terminal and server optimizes overall system performance and exemplifies a technical configuration that is distinguishable from conventional centralized recommendation engines.

In yet another embodiment, the server may integrate additional model architectures. For example, the server may use a feed-forward neural network to pre-rank candidates based purely on numerical features, and then apply the transformer-based generative AI model with full prompt sentences only to a smaller subset of high-potential candidates. This two-stage architecture reduces the computational burden on the transformer model while preserving recommendation quality, resulting in a technical effect of increased scalability in environments with large user populations.

Through these embodiments, the server uses an integrated pipeline of structured data handling, prompt sentence generation, neural network-based embedding and similarity operations, and rule-guided ranking to improve computer functionality in recommendation tasks. The use of generative AI models in conjunction with explicit feature weighting and adaptive prompt construction enables the system to process complex preference spaces more efficiently and accurately than traditional systems, and provides a reproducible, machine-implemented mechanism for continuous technical improvement of matching operations.

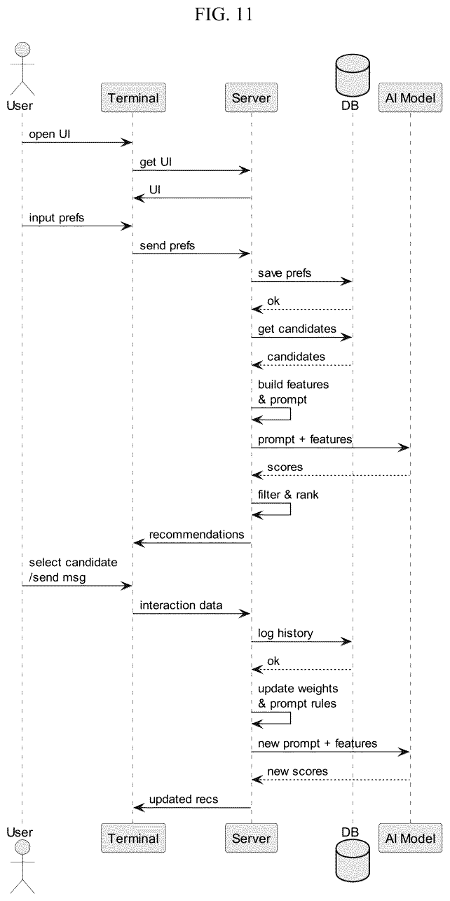

The following describes the processing flow using FIG. 11.

### Step 1

The terminal displays an input interface.

The terminal loads a user interface from the server and renders input components, such as text boxes, drop-down lists, and check boxes, on a display. The input of this step consists of markup data (for example, HTML and style data) and control scripts received from the server. The terminal uses these inputs to generate a graphical screen that allows the user to specify attribute conditions and preference information. The output of this step is a visible screen interface through which the user can operate input components.

### Step 2

The user inputs attribute conditions and preference information.

The user operates the terminal by typing into text boxes, selecting values from drop-down lists, and checking boxes corresponding to desired attributes such as age range, professional field, interest categories, and geographical region, as well as free-form preference text describing desired traits or activities. The input of this step is the screen interface presented on the terminal. The user's actions convert the visual interface into structured input values stored temporarily in the terminal's memory. The output of this step is a set of raw user-entered values, including numeric ranges, categorical selections, and free-form text strings.

### Step 3

The terminal validates and structures the input data.

The terminal executes client-side validation scripts to check for missing mandatory fields, inconsistent ranges, and invalid formats. The input of this step is the raw user-entered values from the previous step. The terminal performs data checking operations, such as comparing minimum and maximum values, validating text length, and matching patterns against allowed formats. The terminal then converts valid entries into a structured data object, such as a key-value mapping that represents age ranges, categories, and text fields. The output of this step is a structured and locally validated user information object ready for transmission.

### Step 4

The terminal transmits structured user information to the server.

The terminal sends the structured user information object to the server through a network interface using an encrypted communication scheme. The input of this step is the structured user information object and connection parameters associated with the server's endpoint. The terminal encapsulates the structured data in a request message, encrypts the payload using a transport layer security protocol, and forwards it to the server over a communication network. The output of this step is an encrypted request containing user information that arrives at the server's network interface.

### Step 5

The server receives, parses, and normalizes user information.

The server accepts the encrypted request, decrypts the payload, and parses the structured user information. The input of this step is the encrypted request containing the structured user information object. The server uses application-layer logic to convert the received representation into internal data structures, such as records containing age bounds, category identifiers, and text strings. The server then performs normalization operations, such as mapping synonymous occupation labels to common category codes, constraining age values to permissible ranges, and trimming or sanitizing text fields. The output of this step is a normalized user information record stored temporarily in server memory.

### Step 6

The server stores normalized user information in an information storage device. The server writes the normalized user information into relational tables in the information storage device. The input of this step is the normalized user information record held in server memory. The server constructs database commands to insert or update entries in user profile tables and preference tables, and executes these commands through a database interface, which performs index updates and consistency checks. The output of this step is a set of persistent records within the relational database, representing the user's attribute conditions and preference information in a form suitable for later retrieval and analysis.

### Step 7

The server retrieves candidate user information from the information storage device.

The server queries the relational database to obtain other user information that can serve as potential target candidates. The input of this step is the current user's normalized information and database query parameters. The server executes selection operations to retrieve records matching broad constraints, such as similar regions or compatible age groups, and filters out records for blocked or incompatible users. The output of this step is a collection of candidate user records that each contain structured attributes and associated descriptive fields.

### Step 8

The server generates numerical feature data and character string feature data.

The server processes both the current user's information and the candidate user information to create feature representations. The input of this step is the set of normalized user records and candidate records from memory and the relational database. The server, via a data conversion unit, encodes categorical attributes into numerical vectors, scales numeric attributes, and tokenizes text segments, including profile descriptions and preference texts. The server may aggregate or average feature values across multiple fields. The output of this step is two sets of feature data: numerical feature data representing structured attributes as vectors, and character string feature data representing tokenized or otherwise processed text.

### Step 9

The server constructs a prompt sentence based on user attributes and preferences.

The server generates a prompt sentence in natural language that expresses the user's attribute conditions and preference information. The input of this step is the normalized user information and the generated feature data. The server merges explicit attribute values and preference descriptors into a textual template, such as:
“I am looking for a partner in their thirties who works in the IT industry and enjoys outdoor activities.”
or
“Recommend professionals in a similar age range, working in the technology sector, who like hiking, camping, and other outdoor hobbies, and who live in or near a specified region.” The server assembles the prompt sentence by inserting actual user-specific values into these template structures. The output of this step is a prompt sentence string that captures the user's intent and is suitable for input to a generative AI model.

### Step 10

The server prepares model input by combining the prompt sentence and feature vectors.

The server converts the prompt sentence into a sequence of token identifiers and corresponding embeddings and combines them with feature vectors derived from numerical and character string feature data. The input of this step is the prompt sentence string and the feature data generated earlier. The server uses an embedding function to map each token to a numeric vector and creates special tokens or additional embedding channels for key feature components representing age, occupation, interests, and region. The server then constructs a model input structure, which may be a sequence of embedding vectors with appended feature embeddings. The output of this step is a combined input representation that encodes both natural language preferences and structured attributes.

### Step 11

The server executes a generative AI model to compute compatibility scores.

The server feeds the combined input representation into a generative AI model implemented as a transformer-based neural network. The input of this step is the sequence of embeddings and associated feature representations. The server causes the model to propagate the input through multiple self-attention layers and feed-forward layers, computing contextual embeddings and attention weights that represent relationships among tokens and feature elements. The server then applies an output transformation to compute similarity scores or ranking scores for each candidate representation, using operations such as dot products between a query embedding and candidate feature embeddings. The output of this step is evaluation information, including a numerical score for each candidate and optional explanation descriptors derived from internal model states.

### Step 12

The server performs rule-based filtering and score correction.

The server applies explicit rules to the evaluation information produced by the generative AI model. The input of this step is the list of candidates with associated scores and any meta-information from the model output. The server executes a filtering process that removes candidates that violate a location condition, a contact history condition, or an exclusion condition, such as those outside a specified region or previously blocked by the user. The server then performs a score correction process by adjusting scores using additional factors, for example boosting scores for underrepresented but previously successful patterns or penalizing recently presented candidates. The output of this step is a refined set of candidate records with adjusted scores and an ordered ranking.

### Step 13

The server generates recommendation result data and sends it to the terminal.

The server composes recommendation result data for presentation to the user. The input of this step is the refined candidate set with adjusted scores and associated attributes. The server selects a subset of top-ranked candidates, collects their attribute fields, and optionally constructs explanatory text summarizing the main reasons for selection. The server packages this information into a response structure, which may include candidate identifiers, profile summaries, match scores, and explanation strings. The server transmits this structure to the terminal through the network interface using an encrypted communication scheme. The output of this step is a recommendation response received by the terminal.

### Step 14

The terminal renders recommendation results for the user.

The terminal receives the recommendation response and updates the display. The input of this step is the structured recommendation result data from the server. The terminal decodes the data and generates visual components, such as cards or list items, for each recommended candidate. The terminal displays candidate attributes, including age, professional field, interest categories, and region, along with a graphical indication of match strength and any explanatory text. The output of this step is a visible list of recommended candidates presented on the terminal screen.

### Step 15

The user reviews recommended candidates and optionally initiates contact.

The user inspects the displayed candidate information and compares visible attributes and scores. The input of this step is the visual display of recommendation results. The user may select a candidate to view more detailed profile information or may choose to send an initial message. When the user decides to contact a candidate, the user composes a message in a text field and confirms sending. The output of this step is message content and a selected candidate identifier entered into the terminal.

### Step 16

The terminal sends interaction data and messages to the server.

The terminal packages the user's interaction data, including which candidates were viewed, selected, or contacted, along with message text where applicable, and transmits this information to the server via encrypted communication. The input of this step is the user's selection and message content. The terminal structures this data into messages that identify the user, the targeted candidate, and the type of interaction, then sends these messages to corresponding endpoints on the server. The output of this step is a set of interaction records and message requests received by the server.

### Step 17

The server records behavior history and updates stored data.

The server receives the interaction data and message content. The input of this step is the set of interaction records and message requests from the terminal. The server stores message content in message tables and records interaction events—such as profile views, message sends, and skips—in behavior history tables within the relational database. The server may also update summary statistics, such as counts of positive interactions with certain attribute combinations. The output of this step is an updated behavior history dataset associated with the user and candidate profiles.

### Step 18

The server updates feature weighting and prompt construction based on behavior history. The server periodically or in response to new interactions reads behavior history information from the database. The input of this step is the behavior history dataset and the existing feature weighting parameters and prompt templates. The server computes updated weights for certain feature dimensions, for example increasing the weight of an interest category that appears frequently among positively contacted candidates, and decreasing the weight of attributes associated with ignored candidates. The server then modifies prompt construction rules to reflect these weights, producing more specific or differently emphasized phrases in future prompt sentences. The output of this step is an updated set of feature weights and revised prompt construction patterns associated with the user.

### Step 19

The server performs re-analysis using the updated prompt sentence and feature data.

The server regenerates feature vectors and constructs a new prompt sentence that incorporates behavior-based refinements, then re-executes the generative AI model. The input of this step is the updated feature weighting, revised prompt construction patterns, and the latest user and candidate data. The server recomputes numerical feature data, reconstructs a new prompt sentence according to the updated templates, combines these into a new model input representation, and runs the generative AI model again to obtain updated evaluation information. The output of this step is a revised set of recommendation scores and candidate rankings, which the server can again filter and transmit to the terminal, thereby iteratively improving the technical quality and efficiency of the recommendation process.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented matching systems typically rely on static rule-based filtering or simple similarity calculations between user attributes and target attributes stored in a database. In such systems, the server generally executes fixed search queries or heuristic scoring functions over profile records. As a result, these systems suffer from several technical limitations.

First, the server is not configured to generate and iteratively refine a machine-interpretable prompt sentence that jointly encodes both a current user's fine-grained preferences and a dynamically changing set of other users' profile information. Because the matching logic is hard-coded in the application layer, the server cannot efficiently leverage a generative AI model to perform high-dimensional semantic analysis over heterogeneous profile data. This leads to lower-quality matching results and increased processing overhead when attempting to approximate nuanced user intentions by ad hoc rules.

Second, conventional systems do not integrate communication support processing into the core matching pipeline at the server level. Typical messaging features merely transmit text between terminals without using a generative AI model to improve message content. As a consequence, the server fails to utilize conversational data as a feedback signal for updating user preference models, and cannot technically adapt subsequent matching computations based on actual interaction history. This results in a static recommendation behavior, where the server does not improve its internal user preference representation over time.

Third, existing architectures usually treat the generative AI model, if present at all, as an optional external tool invoked separately by client devices. In such a design, the server lacks control over how prompt sentences are constructed from stored attribute information, preference information, and communication history. This leads to redundant network traffic, fragmented state across terminals, inconsistent use of model outputs, and increased latency, because each terminal must locally manage AI interactions rather than relying on a centrally optimized server-side process.

Accordingly, there is a need for an improved computer-implemented system in which the server is configured to: (i) construct structured prompt sentences incorporating user attribute information, preference information, and other users' profile information; (ii) invoke a generative AI model under server control to compute matching candidates and communication support suggestions; and (iii) update and utilize refined preference information based on both matching results and communication history to iteratively optimize subsequent matching and communication processes. Such a configuration improves the functioning of the server and the overall information processing system by enabling more efficient use of computational resources, more accurate and adaptive matching, and more consistent server-managed interaction with the generative AI model.

The specific processing by the specific processing unit 290 of the data processing device 12 in Application Example 1 is realized by the following means.

The present invention provides a server comprising a processor configured to receive, from a user terminal, attribute information and preference information of a user, store the received attribute information and preference information as profile information in an information storage medium, acquire profile information of other users from the information storage medium, generate a prompt sentence for a generative AI model based on the preference information of the user and the profile information of the other users, input the prompt sentence into the generative AI model to cause the generative AI model to generate matching candidates, analyze an output of the generative AI model to generate recommendation information including identification information and evaluation information for the other users, transmit the recommendation information to the user terminal, receive, from the user terminal, identification information of another user selected by the user and communication text information, generate a further prompt sentence including the communication text information, input the further prompt sentence into the generative AI model to cause the generative AI model to perform communication support processing, transmit improved communication text information obtained from the communication support processing to the user terminal, record messages between users based on the improved communication text information, and update preference information of the user based on at least one of the matching candidates and a history of the communication support processing to generate a new prompt sentence for subsequent processing. This enables the server to centrally control and optimize interactions with the generative AI model, to perform high-quality, adaptive matching based on evolving user preferences and interaction history, and to provide server-side communication support that improves the effectiveness and efficiency of computer-implemented matching and messaging operations.

The term “system” refers to a combination of one or more hardware devices and one or more software components that cooperatively perform information processing, communication, and control operations described in the claims.

The term “processor” refers to one or more hardware processing units, such as a central processing unit, a microprocessor, or a programmable logic device, configured to execute instructions and perform the functions recited in the claims.

The term “user terminal” refers to an information processing apparatus operated by a user, including but not limited to a mobile terminal, a portable terminal, a desktop terminal, or any other computing device capable of inputting, displaying, and transmitting information.

The term “user interface” refers to a hardware and software configuration on the user terminal that allows a user to input information and receive output information, including graphical user interfaces, text-based interfaces, touch interfaces, and voice-based interfaces.

The term “attribute information” refers to data items representing characteristics of a user, including but not limited to age information, occupation information, interest information, residential area information, business field information, and skill information.

The term “preference information” refers to data items representing desired conditions or requirements specified by a user with respect to a counterpart or target, including but not limited to desired counterpart experience field information and other matching conditions.

The term “profile information” refers to a structured collection of attribute information and preference information associated with a particular user and stored in an information storage medium.

The term “communication device” refers to one or more hardware and software components that provide a communication function between the server and user terminals, including network interfaces, communication controllers, and communication protocols.

The term “information storage medium” refers to a logical or physical storage resource, including main memory, auxiliary storage, database systems, or distributed storage, capable of storing profile information, messages, and related data.

The term “other users” refers to users different from a current user for whom matching or recommendation processing is being performed, and whose profile information is used as candidate information for matching.

The term “generative AI model” refers to a generative artificial intelligence information processing model, such as a machine learning model or neural network model, configured to generate outputs including text, scores, or structured data based on input prompt sentences.

The term “prompt sentence” refers to a sequence of symbols, including natural language expressions and/or structured data, constructed to be input to the generative AI model in order to specify analysis tasks, matching tasks, or communication support tasks.

The term “matching candidates” refers to one or more other users or targets selected or scored by the generative AI model as being suitable or relevant to a particular user based on the user's preference information and the profile information of the other users.

The term “recommendation information” refers to information generated at the server based on outputs from the generative AI model, including identification information for other users, profile information for the other users, evaluation information, and reason information.

The term “identification information” refers to data that uniquely or distinctively identifies a user or another entity within the system, including but not limited to identifiers, indices, or codes.

The term “evaluation information” refers to information indicating a quality, score, ranking, or suitability level associated with a matching candidate, as determined by the generative AI model or subsequent processing.

The term “reason information” refers to explanatory text or data generated by the generative AI model or the processor, indicating why a particular matching candidate was selected or how a certain evaluation was determined.

The term “communication text information” refers to text data representing message content or draft message content input by a user for communication with another user.

The term “communication support process” refers to processing by the generative AI model and the processor to improve, correct, rephrase, or otherwise assist in composing communication text information, including text improvement and proposal of alternative expressions.

The term “improved communication text information” refers to communication text information that has been generated or modified as a result of the communication support process, and is suitable for presentation to or transmission by a user.

The term “message between users” refers to a unit of communication content, including at least part of the improved communication text information or a transmission text based on the improved communication text information, that is stored and relayed among user terminals.

The term “history of the communication support process” refers to data representing past executions of communication support processing, including records of input draft texts, output improved texts, user selections, timestamps, and related metadata.

The term “updated preference information” refers to preference information that has been modified by the processor based on at least one of matching candidates, recommendation information, and the history of the communication support process, in order to reflect refined or inferred user preferences.

The term “new prompt sentence” refers to a prompt sentence generated after an update of preference information, and configured to be input to the generative AI model so as to perform subsequent matching or communication support processing with improved parameters.

In one embodiment, a server, a plurality of terminals, and a network-based generative AI model cooperate to implement the claimed system. The server includes at least one hardware processor, a main memory, a non-volatile storage device, and a network interface. The terminals each include a hardware processor, a memory, a display device, an input device, and a wireless or wired communication interface. The server executes server-side application software implemented, for example, on an operating system such as a general-purpose server OS, a web server framework, an application framework, and a database management system. The terminal executes client-side application software implemented, for example, as a native mobile application on a mobile operating system or as a web application on a browser.

The server stores profile information, preference information, recommendation information, and communication text information in at least one database system implemented on a storage device. The server uses a relational schema including a user table, a profile table, a preference table, a candidate table, a recommendation table, and a message table. Each table record includes identifiers, timestamps, and fields for attribute information such as age information, occupation information, interest information, residential area information, business field information, skill information, and desired counterpart experience field information. The server uses indexes on selected fields, for example composite indexes on business field information and skill information, to accelerate retrieval of candidates and to reduce disk I/O operations.

The server uses a generative AI model deployed as a network-accessible inference service. In one embodiment, the generative AI model is implemented as a transformer-based neural network including multiple self-attention layers, feed-forward layers, and normalization layers. The model is trained on a corpus that includes textual data describing user attributes, professional roles, skills, and communication patterns. The model uses token embeddings, positional encodings, multi-head attention mechanisms, and layer normalization to compute contextualized representations of tokens in a prompt sentence.

The server uses the generative AI model in two distinct technical contexts. First, the server uses the model for matching candidate selection. Second, the server uses the model for communication support processing. In each context, the server generates a prompt sentence that encodes structured data stored in the database into a sequence of symbols according to a predetermined formatting rule. The server converts profile information and preference information into constrained natural language templates with explicit delimiters so that the model can reliably parse the information.

The server controls the way in which profile information and preference information are serialized, combined, and truncated before being sent to the generative AI model. The server uses fixed label tokens, such as “USER_PROFILE:”, “PREFERENCE:”, and “CANDIDATE_PROFILE:”, followed by field names and field values. The server thereby imposes a machine-readable structure on the prompt sentence. This structure reduces ambiguity and allows the model to treat each candidate as a separate segment, thereby improving the accuracy and speed of attention computations in the model.

The server stores a representation of each user's preference information not only as human-readable strings but also as a vector of numerical weights for each attribute category, such as weights for business field similarity, skill similarity, experience length, and geographic proximity. The server computes these weights using a learning procedure based on interaction logs and accepted recommendations. The server then encodes these weights into the prompt sentence, for example by textual tokens such as “PREFERENCE_WEIGHT_BUSINESS_FIELD: 0.8” or “PREFERENCE_WEIGHT_SKILL: 0.9”. This encoding allows the generative AI model to perform a non-conventional matching process, where the model simultaneously reads semantic descriptions of users and explicit weight values, and thereby performs a multi-criteria evaluation that cannot be trivially replicated by a simple rule engine. The server uses a training method for the generative AI model that includes supervised fine-tuning and reinforcement-style preference optimization. In supervised fine-tuning, the server (or a training environment) provides pairs of input prompt sentences and desired outputs such as ranked candidate lists with explanations. The training procedure uses a loss function combining cross-entropy loss on target token sequences and pairwise ranking loss on candidate scores. The model parameters, including attention weights and feed-forward parameters, are updated using a gradient-based optimizer, such as an adaptive gradient algorithm, to minimize the combined loss over a training dataset.

The server optionally uses a reinforcement-style preference update, where user feedback on recommendations (for example, message replies, long conversations, or explicit likes) is treated as a signal that increases the reward for particular candidate selections. The server aggregates these signals into preference vectors and encodes them into the training targets, thereby guiding the model to assign higher scores to candidates that historically lead to effective communication. This training pipeline results in a model that uses learned patterns of successful interactions rather than simply implementing deterministic rules.

The server communicates with the generative AI model through a network interface using a defined request-response protocol. The server sends a serialized prompt sentence as a character sequence or token sequence, along with control parameters such as maximum output length and sampling temperature. The server receives a response that includes a structured textual representation of matching candidates, each candidate including an identifier, a score, and a reason. The server parses this response using a deterministic parser that recognizes predefined labels and fields. The server then performs data type conversions, mapping identifiers to database keys, and converts textual scores to numeric types.

The server uses the matching results to form recommendation information. The server joins the identifiers output from the generative AI model with the corresponding profile information stored in the database and compiles recommendation information that includes identification information, profile summaries, scores, and explanations. By centralizing this processing, the server reduces duplicated computation on each terminal and enforces consistent parsing and security policies.

The terminal provides a user interface that allows a user to input attribute information and preference information, view recommended candidates, and compose communication text information. The terminal sends data to the server using structured requests, for example HTTP/HTTPS, and displays server responses in graphical components. The terminal does not implement its own generative AI inference; instead, the terminal depends on the server's centralized generative AI processing, thereby reducing computational requirements on the terminals and preventing fragmentation of AI interactions.

The user uses the terminal to input initial attribute information, such as “Software engineer, interested in marketing and business development, located in a certain region,” and preference information, such as “Interested in counterparts with rich marketing experience in B2B SaaS and startup backgrounds.” The terminal converts this input into structured data and sends it to the server, which stores it in the database and integrates it into the profile information associated with the user.

The server converts this profile information and preference information into a prompt sentence for the generative AI model. An example of a prompt sentence for matching is: “You are a matching assistant. USER_PROFILE: occupation=software engineer; interests-marketing, business development; region=[region]. PREFERENCE: prefers partners with strong marketing experience in B2B SaaS and startup backgrounds. CANDIDATE_PROFILE_1: occupation-marketing manager; industry=SaaS; skills=B2B marketing, growth; experience=10 years. CANDIDATE_PROFILE_2: occupation=product manager; industry=technology; skills=product marketing, strategy; experience-5 years. Analyze the user's preferences and the candidate profiles. Return the top 2 matching candidates with a numeric score from 0 to 100 and a brief reason for each in a structured, labeled format.”

The server serializes multiple candidate profiles in this manner. The use of consistent label tokens and field separators allows the generative AI model to internally assign separate attention contexts to each candidate profile, thereby enabling a high-dimensional comparison of user preferences and candidate attributes. Because the server constructs the prompt sentence in a standardized and compressed form, the server reduces the number of tokens consumed per candidate. This reduces network payload size and inference latency, which is a technical improvement over naïve free-text descriptions for each candidate.

After receiving the model's output, the server normalizes the scores and optionally applies an additional algorithm, such as a weighted average of the model score and a deterministic similarity score based on vectorized attributes. The server thus combines the non-linear semantic reasoning capabilities of the generative AI model with an efficient vector-based scoring module. This hybrid method improves both the ranking stability and computational efficiency, compared to systems that rely solely on either a static rule engine or an unconstrained neural model.

For communication support, the user composes a draft message on the terminal, for example: “Hi. I want to talk.” The terminal sends the draft message to the server. The server builds another prompt sentence:

“Rewrite the following networking message in a polite, professional, and friendly tone suitable for a business event, keeping the intent but improving clarity: ‘Hi. I want to talk.’ Provide a single rewritten message.”

The server can optionally add limited recipient context, such as “The recipient has 10 years of experience in B2B SaaS marketing and is currently a marketing leader.” The server sends this prompt sentence to the generative AI model, which generates a revised message, for example: “Hello, I saw that you have extensive experience in B2B SaaS marketing. I am working on a new SaaS product and would appreciate the opportunity to hear your thoughts on go-to-market strategies. Would you be open to a brief conversation during this event?” The server then returns this improved communication text information to the terminal. The user can directly send this message or further modify it. The server stores the final message and associates it with the sender and recipient in the message table.

The server uses the history of communication support processing to update internal preference information. For example, if the user consistently accepts AI-improved messages that emphasize “go-to-market strategy” and “startup growth,” the server increments weights for related features in the preference vector. The server stores this updated preference information and incorporates it into subsequent prompt sentences, such as:
“The user's updated preferences emphasize connections with strong experience in go-to-market strategy and startup growth. Take this into account when ranking the following candidate profiles.”

By feeding these updated weights and textual cues into the generative AI model, the server guides the model to prioritize candidates aligned with actual communication behavior rather than solely relying on the original static preferences. This yields a technical effect where the matching function is adaptively calibrated to implicit signals derived from interaction logs.

The server thereby improves computer technology in several ways. The server reduces computation at the terminals by centralizing generative AI inference and prompt management, thereby conserving battery and processing resources on mobile devices. The server reduces network bandwidth usage by encoding necessary data in compressed and structured prompt sentences, avoiding repeated transfer of redundant profile information. The server improves recommendation accuracy and stability by combining structured prompt encoding, learned preference weights, and hybrid scoring algorithms. The server also improves data management by maintaining a consistent database-backed state of user profiles, preferences, and communication histories that is directly incorporated into server-generated prompts.

The generative AI model itself operates according to an internal sequence of operations not achievable by conventional rule-based engines. The model converts token sequences into high-dimensional vectors, applies multi-head self-attention to compute context-dependent representations of profile attributes and preferences, and generates output sequences containing candidate identifiers, scores, and explanatory tokens. During training, the model updates internal weights according to error gradients computed from a defined loss function that penalizes incorrect ranking orders and poorly formed explanations. This weight update mechanism allows the model to capture complex non-linear correlations between attributes and preferences, reducing errors in matching and message generation beyond simple keyword matching or linear similarity measures.

The server enforces non-conventional processing rules when constructing prompt sentences and interpreting model outputs. The server uses strict field ordering, fixed labels, and deterministic parsing rules to ensure that the same physical token sequence always corresponds to the same logical field. This design allows the server to treat the generative AI model as a computation engine operating on a well-specified input format and guarantees that the outputs can be mapped back into database structures without ambiguity. This tight integration results in stable behavior and reduces processing errors when scaling to large numbers of users and candidate profiles.

In alternative embodiments, the server can employ different types of generative AI models, including encoder-decoder architectures or mixture-of-experts architectures, provided that the server constructs compatible prompt sentences and parsers. The server can also vary the number of layers, hidden units, attention heads, or training datasets to optimize for latency, memory usage, or domain specificity. The server can further integrate vector embedding modules that pre-compute dense embeddings for profile attributes and store them in a vector index, such as a k-nearest neighbor index. In such variations, the server can use the generative AI model to generate refined candidate sets or re-rank candidates retrieved from the vector index.

The terminal may be a mobile computing device, a tablet, or a desktop device. The terminal can implement different user interfaces, but in each case, the terminal delegates heavy computation to the server. The user can be an individual participating in a networking event or any other context where profile-based matching and communication support is useful. The core technical functions-prompt construction, generative AI inference coordination, preference update, and hybrid scoring-remain executed and controlled by the server, ensuring that the claimed system is directed to a specific manner of operating a computer system and a generative AI model to achieve improved technical performance, rather than merely automating a human mental process.

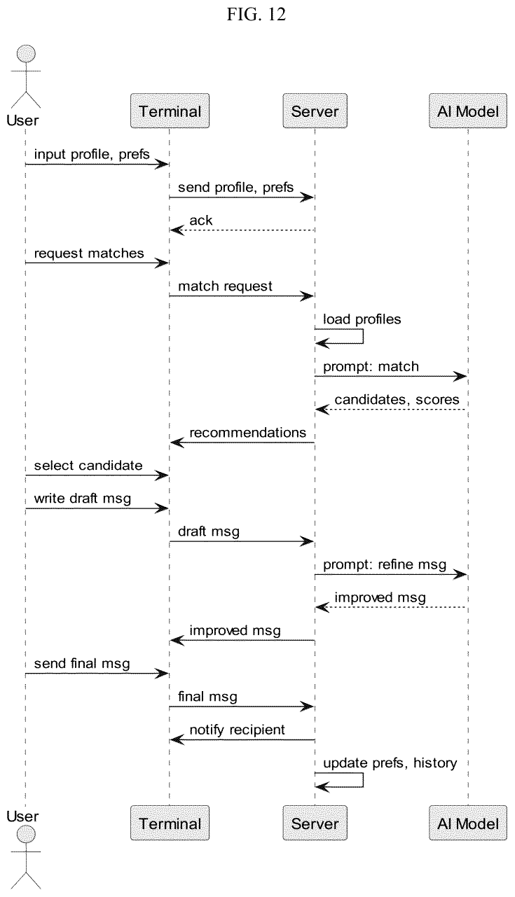

The following describes the processing flow using FIG. 12.

### Step 1

The user operates the terminal to input attribute information and preference information.

The terminal displays input fields for items such as age, occupation, interests, residential area, business field, skills, and desired counterpart experience fields.

Input: Raw user keystrokes and selections on the terminal UI.

Processing: The terminal converts the keystrokes and selections into structured data objects, performs local validation (format checks, required fields), and encodes the data into a JSON or equivalent structured representation.

Output: Validated, structured attribute information and preference information ready to be transmitted to the server.

### Step 2

The terminal transmits the structured attribute information and preference information to the server.

The terminal opens a secure network connection (for example, HTTPS) and sends an API request containing the structured data to a designated endpoint on the server.

Input: Structured profile data (attribute information and preference information) created in Step 1.

Processing: The terminal serializes the structured data into a request body, attaches authentication tokens, and sends the request through the communication interface to the server.

Output: A network request containing the user's attribute information and preference information delivered to the server.

### Step 3

The server receives and stores the user's attribute information and preference information as profile information.

The server parses the received request, extracts individual fields, and maps them to a relational schema in a database.

Input: Network request with structured attribute information and preference information received from the terminal.

Processing: The server validates field values, generates or retrieves a user identifier, and executes database insert or update operations (for example, SQL commands) to store the data into profile tables and preference tables. The server may normalize strings, index key fields, and compute initial numeric preference weights.

Output: Persisted profile information and preference information stored in the information storage medium and associated with the user identifier.

### Step 4

The user requests matching candidates from the terminal.

The terminal presents a control such as a “Find partners” button, and the user activates this control to initiate matching.

Input: User action (button activation or equivalent UI event) indicating a request for partner recommendations.

Processing: The terminal creates a request containing the user identifier or session token and sends it to the server via the network interface.

Output: A matching request message transmitted from the terminal to the server.

### Step 5

The server acquires the user's profile information and candidate profile information from the database.

The server retrieves the requesting user's stored profile information and preference information and identifies other users as potential candidates.

Input: Matching request including the user identifier received from the terminal. Processing: The server executes database queries to read the user's profile and preference records, and executes additional queries to obtain profile records of other users that satisfy basic constraints (for example, same event, active status). The server may preprocess candidate data by filtering on coarse attributes (such as business field) to reduce the number of candidates.

Output: A set of profile information for the requesting user and a set of candidate profile information for multiple other users in memory on the server.

### Step 6

The server constructs a prompt sentence for the generative AI model based on the user and candidate profiles.

The server converts database records into a structured natural language format with explicit labels and delimiters.

Input: In-memory profile information for the user and the candidate users obtained in Step 5, plus stored numeric preference weights if available.

Processing: The server formats a prompt sentence that includes labeled sections such as “USER_PROFILE: . . . ”, “PREFERENCE: . . . ”, and “CANDIDATE_PROFILE n: . . . ” for each candidate. The server embeds attribute values and preference weights into these sections, arranges candidates in a fixed order, and truncates or summarizes text fields to respect token limits. The server also appends instructions describing the required output structure (for example, list of top candidates with scores and reasons).

Output: A complete prompt sentence for matching, represented as a text string ready to be sent to the generative AI model.

### Step 7

The server sends the prompt sentence to the generative AI model and obtains matching candidates.

The server calls a network-based inference service that implements the generative AI model.

Input: Prompt sentence text constructed in Step 6, together with control parameters (for example, maximum tokens, temperature).

Processing: The generative AI model tokenizes the prompt sentence, converts tokens to embeddings, applies multi-head attention and feed-forward operations layer by layer, and generates an output sequence that encodes a ranked list of candidate identifiers, scores, and reasons. The server receives this output, verifies the response structure, and parses the fields according to the labels and delimiters specified in the prompt.

Output: Parsed matching candidates data, including candidate identifiers, numeric scores, and textual reason information stored in server memory.

### Step 8

The server generates recommendation information from the matching candidates and associated profiles.

The server combines AI-generated scores and reasons with database-stored profile records to form complete recommendations.

Input: Parsed candidate identifiers, scores, and reasons from Step 7, and corresponding profile records retrieved from the database.

Processing: The server joins candidate identifiers with profile records, normalizes scores (for example, scales to 0-100), optionally computes hybrid scores by combining AI scores with deterministic similarity metrics, and selects top candidates according to ranking criteria. The server forms recommendation information objects that contain identification information, profile attributes, evaluation information, and reason information.

Output: A recommendation list containing structured recommendation information for a set of matching candidates.

### Step 9

The server transmits the recommendation information to the terminal for real-time display. The server sends the selected recommendation list as a response to the matching request. Input: Recommendation list built in Step 8 and an established communication channel to the terminal.

Processing: The server serializes the recommendation information into a response format, attaches appropriate status codes, and transmits the response through the network interface.

Output: A response message containing recommendation information delivered to the terminal.

### Step 10

The terminal receives and displays the recommendation information to the user.

The terminal parses the server response and updates the user interface.

Input: Recommendation response from the server containing candidate identification information, profile summaries, scores, and reasons.

Processing: The terminal deserializes the data, maps it into UI components, and renders a list or grid of candidate entries. The terminal may sort or filter data as instructed by the server or by local user settings, and displays key fields (name, occupation, business field, score, brief reason).

Output: Visual presentation of recommended candidates on the terminal's display, enabling the user to review and select candidates.

### Step 11

The user selects a recommended candidate and composes a draft message on the terminal. The terminal captures the user's selection and text input.

Input: User selection of a candidate entry and text entered into a message input field.

Processing: The terminal associates the selected candidate's identification information with the draft communication text information and creates a data structure representing a draft message. If the user requests AI refinement, the terminal flags this request in the data structure.

Output: A draft message object including sender identifier, recipient identifier, and draft communication text information.

### Step 12

The terminal transmits the draft communication text information and identifiers to the server.

The terminal sends an API request for communication support.

Input: Draft message object created in Step 11.

Processing: The terminal serializes sender and recipient identifiers and the draft communication text information into a request body, adds an indicator requesting AI-based communication support, and sends the request to the server via the communication interface.

Output: A communication support request delivered to the server containing all data necessary for AI-based refinement.

### Step 13

The server constructs a communication support prompt sentence for the generative AI model.

The server prepares text that instructs the model how to improve the draft message.

Input: Draft communication text information, sender and recipient identifiers, and optionally stored profile data for both parties.

Processing: The server retrieves relevant profile information (for example, recipient's role and experience) and embeds it into a structured instruction, such as:
“Rewrite the following networking message in a polite, professional, and friendly tone suitable for a business event, keeping the intent but improving clarity. The recipient has [profile attributes]. Message: ‘[draft text]’.”

The server formats this into a prompt sentence, ensuring consistent labels and delimiters.

Output: A communication support prompt sentence ready for input to the generative AI model.

### Step 14

The server sends the communication support prompt sentence to the generative AI model and obtains an improved message.

The server again uses the network-based inference service.

Input: Communication support prompt sentence from Step 13 and control parameters for generation.

Processing: The generative AI model encodes the prompt, applies the neural network layers, and generates an output sequence that represents an improved communication text. The server receives this output, validates that it conforms to expected format, and extracts the improved message string.

Output: Improved communication text information stored in memory on the server.

### Step 15

The server transmits the improved communication text information to the terminal and records the message.

The server returns the refined message for user confirmation and stores a log entry.

Input: Improved communication text information from Step 14 and message metadata (sender, recipient, timestamps).

Processing: The server writes the improved communication text information and associated metadata into a message table in the database, marking it as a suggested or draft message. The server then serializes the improved text and sends it to the terminal as a response.

Output: A response to the terminal containing the improved communication text information, and a stored message record in the database.

### Step 16

The user reviews the improved communication text information on the terminal and sends the final message.

The terminal displays the improved text and captures the user's confirmation.

Input: Improved communication text information received from the server and user confirmation action (for example, tapping a “Send” button).

Processing: The terminal may allow further editing; once confirmed, the terminal creates a final message object based on the improved text and sends a send-message request to the server.

Output: A final message send request including sender and recipient identifiers and final communication text.

### Step 17

The server delivers the final message to the recipient terminal and updates communication history.

The server ensures that the message is available to the recipient.

Input: Final message send request from the terminal in Step 16.

Processing: The server updates the message record status to “sent,” creates or updates a conversation thread entry, and pushes a notification to the recipient terminal using a messaging channel. The server may use push notification services or persistent connections to alert the recipient terminal.

Output: A stored, marked-as-sent message in the database and a notification delivered to the recipient terminal.

### Step 18

The server updates user preference information based on matching and communication history.

The server refines internal models of the user's preferences.

Input: Matching candidates and scores from Step 7, recommendation interactions from Step 10 (such as which candidates the user selected), and communication history from Steps 15-17 (such as which messages led to continued conversations).

Processing: The server aggregates these data points, adjusts numeric preference weights for various attributes, and stores updated preference vectors in the database. The server then encodes the updated preference information into future prompt sentences so that subsequent matching and communication support requests use refined, user-specific parameters.

Output: Updated preference information linked to the user in the database and modified parameters for construction of future prompt sentences.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional recommendation and matching systems typically treat user input as a set of static filter conditions and directly apply the conditions to a database search. In such systems, text-based preference data entered by a user is often reduced to simple keyword matching or fixed attribute filters, and is not transformed into a rich, structured preference model. As a result, these systems suffer from limited expressiveness in capturing nuanced user intent, and they frequently fail to identify suitable candidates when the user's natural language input does not exactly match stored attribute labels.

In addition, conventional systems often separate database retrieval logic and recommendation logic from generative models used for natural language output. A generative model may be used only as a superficial front-end to rephrase already computed results, without being provided with structured similarity information or detailed preference models. In such architectures, the generative model cannot effectively leverage underlying relevance scores or structured attributes, which leads to poor controllability of generated texts, inconsistent explanation quality, and inability to systematically optimize recommendation behavior. Furthermore, typical architectures do not include a unified processing pipeline in which (i) user preferences expressed in natural language are normalized into upper-level categories, (ii) the normalized preferences are hierarchically expanded using a relatedness table or ontology, (iii) candidate entities are numerically represented and scored using similarity computation, and (iv) the resulting structured analysis information is integrated into a controlled prompt sentence for a generative AI model. The absence of such a pipeline causes inefficiencies, including repeated ad hoc transformations, non-reproducible scoring logic, and difficulty in improving recommendation performance by adjusting a limited number of well-defined control parameters.

Moreover, conventional systems frequently lack explicit mechanisms for constructing prompt sentences that embed both structured preference models and computed similarity scores as machine-readable context, together with explicit control text specifying output format and style. Without such mechanisms, the system cannot reliably generate recommendation texts that reflect both the underlying ranking logic and user-specific constraints, nor can it guarantee consistency of output forms required for downstream user interface components or logging systems.

Accordingly, there is a need for an improved computer-implemented system and server-side processing architecture that (1) transforms natural language user input into a structured and hierarchically expanded preference model, (2) performs similarity computation between the preference model and candidate entities using numerical feature values, and (3) constructs controlled prompt sentences for a generative AI model by embedding structured analysis information and explicit control text, thereby improving the technical functioning of the recommendation pipeline, the controllability of generated outputs, and the efficiency with which computing resources are used to produce personalized recommendations.

The specific processing by the specific processing unit 290 of the data processing device 12 in Example 2 is realized by the following means.

The present invention provides a server comprising a processor and a memory storing instructions which, when executed by the processor, cause the processor to receive, from a terminal, user input including desired conditions and characteristics of a target entity via a communication device; to analyze text information included in the user input using a natural language processing algorithm to extract expressions and feature information, to generate a preference model of the user as structured data based on an extraction result, and to refer to a data structure stored in an information storage device to hierarchically expand the preference model; to generate, based on the expanded preference model, a query command for an information storage device in which attribute information of candidate entities is stored, and to retrieve candidate entities in accordance with a correspondence between the preference model and the candidate entities; to convert attribute information of the retrieved candidate entities and the preference model of the user into numerical feature values, to apply a similarity computation algorithm based on the numerical feature values to calculate a similarity score indicating a degree of suitability of each candidate entity with respect to a preference of the user, and to select candidate entities based on the similarity score; and to integrate analysis information including the preference model of the user, attribute information of the selected candidate entities, and the similarity score into text data, to generate a prompt sentence including the analysis information and control text specifying an output format and an output style, to input the prompt sentence into a generative AI model, to obtain a recommendation text expressed in natural language from the generative AI model, and to generate output data in which the recommendation text is associated with identification information of the selected candidate entities and transmit the output data to the terminal. This enables a computer-implemented recommendation pipeline in which user preferences expressed in natural language are systematically transformed into a hierarchically expanded preference model, numerically compared with candidate entities, and fed as structured context and control information to a generative AI model, thereby improving the accuracy, consistency, and controllability of recommendation texts, and enhancing the overall technical performance and resource efficiency of the server-side recommendation system.

The term “terminal” refers to an information processing device, such as a client computing device or communication apparatus, that provides a user interface for receiving user input and presenting output data received from a server.

The term “communication device” refers to a hardware and software communication module configured to transmit and receive data between the terminal and the server over a communication network, using a predetermined communication protocol.

The term “server” refers to an information processing apparatus comprising at least one processor and at least one memory, configured to execute programs that perform analysis, retrieval, similarity computation, and generation of recommendation information based on user input and stored data.

The term “processor” refers to a hardware processing unit, such as a central processing unit or other computing circuitry, configured to execute instructions stored in a memory to perform the operations described in the present specification.

The term “memory” refers to a storage medium, such as a volatile or non-volatile storage device, configured to store instructions and data for use by the processor.

The term “information storage device” refers to a storage subsystem, including one or more physical or logical storage media, configured to store structured or unstructured data such as user profiles, candidate entity attributes, preference models, and relatedness tables.

The term “user input” refers to information supplied by a user via the terminal, including text information expressing desired conditions and characteristics of a target entity, and optionally including attribute values such as age range, location, and preference parameters.

The term “text information” refers to character-based data, including natural language sentences or phrases, that are included in the user input or generated by processing results, and that are subject to analysis or generation by natural language-related algorithms.

The term “desired conditions” refers to requirements, constraints, or preferences indicated by the user regarding a target entity, such as preferred attributes, behaviors, locations, or other selection criteria.

The term “characteristics of a target entity” refers to properties or attributes of an entity to be recommended or selected, such as demographic attributes, behavioral attributes, interest attributes, or other descriptive features.

The term “candidate entities” refers to entities stored in the information storage device as potential targets of recommendation or selection, each associated with attribute information used for comparison with a user's preference model.

The term “attribute information” refers to data representing properties or features of candidate entities, including structured values such as categories, tags, numerical values, and textual descriptions.

The term “natural language processing algorithm” refers to a computational procedure or software module that processes text information expressed in a natural language to perform tasks such as tokenization, part-of-speech tagging, entity recognition, keyphrase extraction, normalization, or semantic analysis.

The term “expressions” refers to linguistic units, such as words, phrases, or entities, extracted from text information by the natural language processing algorithm as candidates for representing user preferences or entity attributes.

The term “feature information” refers to data derived from expressions or other components of text information, including features used to construct the preference model or to represent candidate entities, and including categorical, numerical, or embedding-based representations.

The term “preference model” refers to a structured representation of a user's preferences, generated based on user input and analysis results, and including categories, tags, and associated parameters used for retrieval, similarity computation, and recommendation.

The term “structured data” refers to data organized in a predetermined format, such as key-value pairs, tables, or records, enabling systematic processing, retrieval, and transformation by the server.

The term “data structure” refers to an organized arrangement of data elements, such as lists, trees, graphs, or tables, stored in the information storage device and used to support hierarchical expansion, lookup, or association of preference-related information.

The term “hierarchically expand” refers to a processing operation in which an initial preference model is augmented by adding related categories, tags, or attributes, based on hierarchical or relational information contained in the data structure, so as to represent broader or more detailed preferences.

The term “query command” refers to an instruction or statement generated by the processor for retrieving data from the information storage device, including database queries or search requests specifying conditions derived from the preference model.

The term “correspondence between the preference model and the candidate entities” refers to a relationship definition or mapping that associates elements of the preference model, such as categories or tags, with corresponding elements of attribute information of candidate entities for use in retrieval and comparison.

The term “numerical feature values” refers to numeric representations of aspects of the preference model and candidate entities, including scalar values, vectors, or matrices, derived from attributes or text and suitable for similarity computation.

The term “similarity computation algorithm” refers to a computational method or procedure that calculates a measure of similarity or distance between numerical feature values representing the preference model and candidate entities.

The term “similarity score” refers to a numeric value output by the similarity computation algorithm, indicating a degree of suitability, closeness, or relevance of a candidate entity with respect to the user's preference model.

The term “analysis information” refers to aggregated data produced by the server, including at least the preference model of the user, attribute information of selected candidate entities, and associated similarity scores, which is used for generating a prompt sentence.

The term “prompt sentence” refers to text data provided as input to a generative AI model, including analysis information and optionally control text, and designed to condition or guide the generative AI model in generating recommendation text.

The term “generative AI model” refers to a machine learning model configured to generate text expressed in natural language in response to input text, such as a prompt sentence, by using learned parameters obtained through training on text data.

The term “recommendation text” refers to natural language output generated by the generative AI model based on the prompt sentence, describing one or more candidate entities and reasons for their selection in a form suitable for presentation to a user.

The term “control text” refers to portions of the prompt sentence that specify constraints or requirements for output generation by the generative AI model, including an output format, an output style, or other control parameters.

The term “output format” refers to a specification of structural requirements for the recommendation text, such as sentence templates, field ordering, or delimiters, which the generative AI model is instructed to follow.

The term “output style” refers to stylistic properties of the recommendation text, such as tone, level of formality, language, or length constraints, which the generative AI model is instructed to apply.

The term “output data” refers to data generated by the server for transmission to the terminal, including at least the recommendation text and identification information of selected candidate entities.

The term “identification information” refers to data that uniquely or persistently identifies each candidate entity within the system, such as an identifier, index, or reference key.

The term “behavior history information” refers to recorded data representing user actions over time within the system, including past searches, selections, interactions, or feedback related to candidate entities.

The term “past input history information” refers to previously stored user inputs, including earlier preference statements, attribute selections, or profile modifications, which are used together with current input to construct the preference model.

The term “relatedness table” refers to a data table or equivalent data structure stored in the information storage device that defines relationships between categories, tags, or attributes, and is used to determine related tags for hierarchical expansion or preference deepening. The term “preference deepening process” refers to processing that enriches the preference model by adding related tags or categories based on the relatedness table, thereby expressing implicit or extended user preferences beyond explicitly entered conditions.

The term “screen display” refers to visual presentation of information on a display apparatus of the terminal, including text, images, and interactive elements for conveying the recommendation text and associated candidate entity information to the user.

In one embodiment, a server, a terminal, and a communication network cooperate to implement the claimed system. The server includes at least one processor, at least one memory, and at least one information storage device such as a relational database system and a non-volatile storage medium. The terminal includes a processor, a memory, a display unit, an input unit such as a touchscreen, and a communication interface configured to communicate with the server via a network using a predetermined protocol such as HTTPS over TCP/IP.

The server executes an application program implemented, for example, on a general-purpose operating system such as a server operating system, and using a web application framework such as a generic web framework. The server further utilizes a database management system such as a relational database engine, an in-memory data store, and a log management system. The server employs a natural language processing library such as a syntactic and semantic analysis toolkit and a machine learning framework such as a tensor computation framework to perform feature extraction, vectorization, and similarity computation. The server also accesses a generative AI model implemented as a neural network language model running either as a cloud-based inference service or as an on-premise model on a hardware accelerator such as a graphics processing unit.

The terminal presents a graphical user interface implemented, for example, using a mobile application framework or a web browser rendering engine. The user operates the terminal to input preference information, including natural language text describing desired conditions and characteristics of a target entity. The terminal converts the input into structured request data and transmits the request data to the server via the communication interface. The terminal receives output data from the server, including recommendation text and identification information of selected candidate entities, and presents the information on the display unit. The terminal may cache portions of the received data in its memory to reduce subsequent communication load and to improve responsiveness.

The server stores user profiles, candidate entity attributes, preference models, and relatedness information in the information storage device. In one example, the server stores each user profile as a row in a relational table containing fields for demographic attributes, categorical tags, and free-text profile descriptions. The server stores candidate entities in a similar table, where each candidate entity is associated with an identifier, one or more attribute categories, tags indicating interests or behaviors, and one or more natural language descriptions. The server further stores a relatedness table in which each row expresses a relationship between a base tag and one or more related tags, optionally with a weight indicating the strength of the relationship.

The server uses a natural language processing algorithm to convert text information included in user input into structured feature information. In one embodiment, the server tokenizes text, performs part-of-speech tagging, and applies named entity recognition to identify phrases corresponding to activity types, locations, or other attribute categories. The server then normalizes extracted expressions into upper-level categories by consulting a normalization dictionary stored in the information storage device. For example, the server may normalize terms such as “outdoor activities,” “outdoor sports,” and “going outside” into an upper-level category “OUTDOOR,” and normalize location mentions such as “Tokyo,” “Tokyo area,” and “near Tokyo” into an upper-level category “TOKYO_AREA.” The server constructs a preference model of the user as structured data that includes, for example, a set of category identifiers, associated weights, location categories, and numeric ranges for attributes such as age or distance. The server stores the preference model in a data structure such as a key-value map, a vector of category indices, or a graph representing relationships among categories. The server enhances the preference model by referring to the relatedness table. The server retrieves, for each category in the preference model, a set of related tags and their weights, and adds them to the preference model with attenuated weights. This hierarchical expansion transforms sparse, literal user input into a richer representation that covers semantically related attributes. This operation causes the subsequent similarity computation to become more robust to vocabulary mismatch and data sparsity, thereby improving matching accuracy without requiring manual rule tuning. The server converts both the preference model and candidate entity attributes into numerical feature values. In one embodiment, the server assigns each category or tag to an index in a high-dimensional feature space and constructs a sparse vector in which each dimension corresponds to a category, with a value representing the presence or importance of that category. The server also computes continuous embeddings for text fields using a neural network encoder such as a transformer-based encoder trained on large text corpora. The server concatenates or otherwise combines sparse category vectors and dense text embeddings into unified feature vectors for the user and for each candidate entity. The server applies a similarity computation algorithm to these feature vectors. In one implementation, the server uses cosine similarity between normalized vectors to measure the degree of suitability of each candidate entity relative to the preference model. In another implementation, the server uses a learned similarity function implemented as a shallow neural network or a distance metric learned by metric learning techniques. The server computes a similarity score for each candidate entity and ranks the candidates accordingly. By representing both user preferences and candidate attributes as numerical vectors in a common space, and by using a well-defined similarity algorithm, the server achieves deterministic, reproducible scoring that can be tuned and optimized using offline training and validation. The server then constructs analysis information to be provided to a generative AI model. The analysis information includes at least (i) a summary of the preference model, including main categories and constraints, (ii) attribute information of selected candidate entities whose similarity scores exceed a threshold, and (iii) the similarity scores themselves or rank positions. The server converts the analysis information into a controlled prompt sentence. The prompt sentence includes both the structured content and control text specifying an output format and output style. For example, the server may construct a prompt sentence such as: “You are a matchmaking assistant. The user prefers outdoor activities and wants a partner in the Tokyo area. Here are the top candidate partners:
1. Candidate: Name: A, Age: 31, Location: Tokyo, Hobbies: mountain climbing, trail running, camping, Similarity score: 0.92
2. Candidate: Name: B, Age: 30, Location: Tokyo, Hobbies: hiking, jogging, Similarity score: 0.88

Choose the single best recommended partner and generate one friendly recommendation sentence in English.
Output format: ‘Your recommended partner is [Name]. [Brief reason].’”

The server inputs this prompt sentence into a generative AI model. In one embodiment, the generative AI model is a transformer-based neural network language model comprising multiple self-attention layers, feedforward layers, and layer normalization modules. The model parameters are learned by pre-training on large amounts of text data with an objective function such as next-token prediction. The model weights are stored on a hardware accelerator and loaded into memory during inference. The server transmits the prompt sentence as a sequence of token identifiers to the model. The model processes the sequence through stacked attention and feedforward layers, computing intermediate representations and finally outputting probabilities for each possible next token. The server uses a decoding strategy such as greedy decoding, beam search, or sampling with temperature control to generate a recommendation text.

The server may fine-tune the generative AI model or a smaller adapter module on domain-specific data that includes examples of preference descriptions and corresponding recommendation texts. During training, the server defines a loss function such as cross-entropy between the model's predicted token distribution and ground truth tokens. The server performs gradient-based optimization, such as stochastic gradient descent or an adaptive method, to update the model weights. The server may apply data augmentation techniques such as paraphrasing and template-based expansion to increase the diversity and robustness of training examples. The server may further constrain the model by providing explicit control tokens or delimiters in the prompt sentence to ensure that the recommendation text follows a stable structure that can be parsed or analyzed by downstream modules.

The server's use of the generative AI model provides more than mere human-written text automation. By embedding similarity scores, structured attribute information, and explicit control text into the prompt sentence, the server causes the generative model to generate recommendation text that is directly aligned with the computed ranking logic and system constraints. This reduces inconsistencies where text output would otherwise ignore underlying scores, and reduces the need for post-processing or manual editing. As a result, the server reduces computational overhead associated with re-ranking or rule-based rewriting, and improves the throughput of the recommendation pipeline.

The server transmits the generated recommendation text, together with identification information of selected candidate entities, to the terminal. The terminal displays the recommendation text and may display associated attributes such as age, location, and main interests. The user can, for example, select a candidate entity to view detailed information.

When the user requests new recommendations, the server can reuse cached feature vectors and similarity computations for certain candidates, thereby reducing repeated calculations and network traffic.

This architecture improves computer technology in several respects. First, the hierarchical expansion of the preference model using a relatedness table improves data utilization in the information storage device by leveraging relationships among categories, which a human operator could not systematically apply at scale. This results in higher recall of relevant candidates without sacrificing precision. Second, the numerical encoding and similarity computation pipeline provides a consistent, machine-optimized way to score candidates, which is more efficient and accurate than ad hoc rule systems or purely human-driven evaluation. Third, the controlled prompt sentence construction and integration of analysis information into the generative AI model improves the controllability and determinism of generated texts, which reduces the need for error handling and manual correction, and decreases latency by avoiding multiple model calls or heuristic re-generation. The server, by implementing these steps as a fixed pipeline of data structures and algorithms, achieves better CPU and memory utilization. For example, the server can pre-compute and store candidate entity feature vectors in the information storage device, and only compute user-specific vectors and similarities at request time. This reduces the computational burden for each request and enables hardware resources to be shared efficiently across many concurrent users. Furthermore, the server can batch process similarity computations on a hardware accelerator and can streamline communication with the generative AI model by using compact prompt sentences containing only relevant attributes and top-ranked candidates, thus reducing network bandwidth usage and inference cost.

In another embodiment, the server uses alternative similarity computation algorithms, such as a neural network that takes as input concatenated feature vectors of a user and a candidate entity and outputs a suitability score. The server trains this neural network using supervised learning with labeled pairs of users and candidate entities and an error function such as binary cross-entropy or margin-based ranking loss. The server can incorporate this learned similarity function into the same pipeline, still converting analysis results into prompt sentences for the generative AI model. This variation demonstrates that the system is not limited to a particular similarity metric but instead uses a flexible yet technically constrained framework for numerical comparison and text generation.

In another variation, the server organizes the relatedness information as a graph data structure and uses a graph traversal algorithm to expand the preference model. The server can, for example, use a weighted breadth-first search limited to a predetermined depth to add related categories while controlling expansion size. This graph-based approach systematically extends preferences according to pre-defined technical rules stored in the graph, which yields a quantifiable effect on coverage and matching precision.

The described embodiments show that the server uses a specific set of data structures (relational tables, feature vectors, relatedness tables, graphs), concrete algorithms (natural language processing, normalization, hierarchical expansion, numerical similarity computation, neural network inference), and controlled interactions with a generative AI model via prompt sentences. The server does not merely automate human recommendation behavior but implements a structured, machine-optimized process that improves matching accuracy, computational efficiency, and output consistency. These improvements arise from the interaction between the preference modeling, similarity scoring, and prompt construction components and from the particular way the server integrates them into a unified technical architecture for recommendation generation.

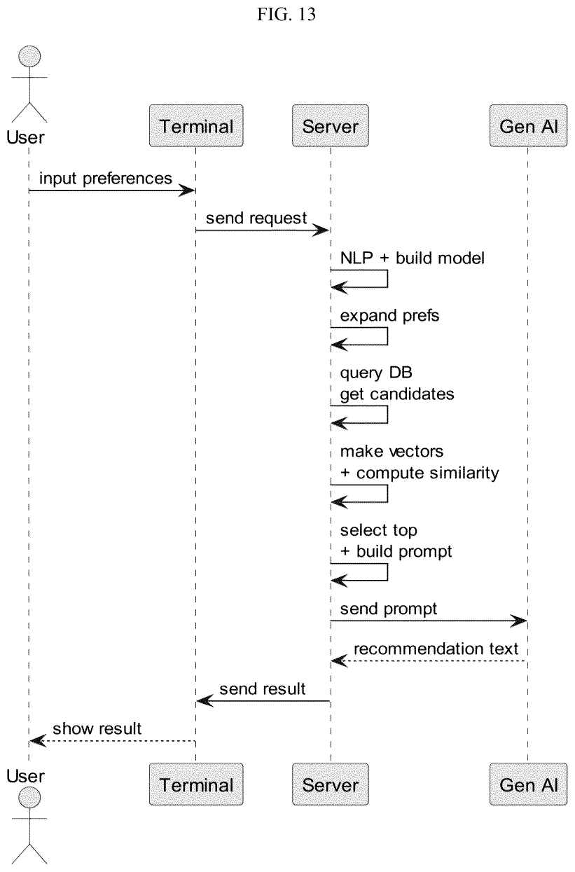

The following describes the processing flow using FIG. 13.

### Step 1

The user operates the terminal to open an application interface and inputs preference information. The terminal displays input fields for natural language text and optional structured fields such as age range, location, and desired attributes. The input is the raw user-entered text and structured values; the output is a structured request object created by the terminal, typically including user identifier, text preference, and attribute values. The terminal validates that mandatory fields are filled, converts numeric fields to a standard numeric format, and then serializes the request object into a data structure suitable for transmission, such as a JSON-encoded message, and sends it to the server via a communication interface.

### Step 2

The server receives the request object from the terminal through a network interface and parses the serialized data. The input is the serialized request message; the output is an internal representation of the request, for example an in-memory object containing text preference, attribute values, and user identifier. The server authenticates the user using a token or session identifier, logs metadata such as timestamp and source address, and performs initial consistency checks on the content. The server then stores a copy of the raw request in a log storage subsystem for later analysis and debugging.

### Step 3

The server applies a natural language processing algorithm to the text preference included in the internal request object. The input is the raw text string; the output is a set of extracted expressions and feature candidates, such as token lists, identified entities, and key phrases. The server uses a syntactic and semantic analysis library to tokenize the text, assign part-of-speech tags, and detect named entities such as hobbies and locations. The server converts each extracted expression into a canonical form by lowercasing, lemmatization, and removal of stopwords, thereby preparing normalized linguistic units for further processing.

### Step 4

The server normalizes the extracted expressions into upper-level categories using a normalization dictionary or lookup table stored in an information storage device. The input is the list of extracted expressions and associated linguistic metadata; the output is a set of category identifiers, such as activity categories and location categories. The server performs dictionary lookups where each expression is matched against entries that map phrases to category codes. If multiple candidate categories are found, the server resolves ambiguity using heuristic rules or scores derived from training data. The server constructs an initial preference model that includes category lists, optional numeric ranges derived from structured input fields, and default weights assigned to each category.

### Step 5

The server hierarchically expands the preference model using a relatedness table or graph stored in the information storage device. The input is the initial preference model containing base categories and weights; the output is an expanded preference model containing both base and related categories with updated weights. The server queries the relatedness table for each base category to obtain related categories and associated relatedness weights. The server computes new weights for related categories by applying a decay function or other weighting rule, and integrates these related categories into the preference model. The server stores the expanded preference model in an efficient data structure, such as a sparse vector representation or a keyed map, for subsequent numerical processing.

### Step 6

The server generates a query command for a database or search index based on the expanded preference model. The input is the expanded preference model containing category identifiers, location constraints, and optional numeric ranges; the output is a query statement or search request suitable for the target storage engine. The server maps categories and attribute constraints to database fields or index terms, constructs a structured query (for example, a relational query or a search index query), and applies filtering conditions derived from the preference model. The server therefore translates high-level preference data into low-level retrieval parameters that can be executed efficiently by the storage engine.

### Step 7

The server executes the generated query command against the information storage device where candidate entities are stored. The input is the query command; the output is a candidate set of entities that satisfy or approximately satisfy the specified conditions. The server sends the query to the database management system or search engine, receives a result set containing rows or documents with attribute information such as identifiers, categories, tags, and text descriptions, and loads the results into memory. The server may also apply post-filtering in memory to discard candidates that violate strict constraints, such as age or prohibited categories.

### Step 8

The server converts the preference model of the user and the attribute information of each candidate entity into numerical feature values. The input is the expanded preference model and the candidate set with their attribute fields; the output is a feature vector for the user and a feature vector for each candidate entity. The server assigns each category and tag to a fixed index in a high-dimensional feature space and sets the value for each dimension according to the weight in the preference model or the presence of the category in candidate attributes. The server also obtains text embeddings for descriptions using a neural text encoder, and combines categorical features and embedding features into unified numerical vectors. The server thereby transforms heterogeneous symbolic data into a uniform numerical representation that is suitable for mathematical similarity computation.

### Step 9

The server computes a similarity score between the user feature vector and each candidate feature vector using a similarity computation algorithm. The input is the user feature vector and the set of candidate feature vectors; the output is a list of similarity scores, each associated with a candidate identifier. The server normalizes the vectors if necessary, applies an algorithm such as cosine similarity or a learned metric function, and calculates a numeric value that represents the degree of suitability of each candidate. The server collects these similarity scores, stores them alongside candidate identifiers, and may discard candidates whose scores fall below a predetermined threshold, thereby reducing the set to those likely to be relevant.

### Step 10

The server selects one or more top-ranked candidate entities based on the computed similarity scores and retrieves detailed attribute information for those candidates. The input is the list of candidate identifiers and associated similarity scores; the output is a refined candidate list containing identifiers, attributes, and similarity scores for selected candidates. The server sorts the candidates in descending order of similarity score, selects a predetermined number of top candidates or those meeting a score condition, and obtains fields such as names, ages, locations, and summarized interests from the information storage device. The server constructs a compact representation of each selected candidate that will be embedded into a prompt sentence.

### Step 11

The server assembles analysis information from the preference model, the selected candidates, and the similarity scores, and constructs a prompt sentence for a generative AI model. The input is the expanded preference model, the refined candidate list, and system-level constraints such as required output format; the output is a prompt sentence in natural language that encodes this information. The server converts the preference model into a textual summary, enumerates the selected candidates with their attribute values and similarity scores, and appends explicit control text specifying the desired output format and style. The server concatenates these components into a single prompt sentence, for example:
“You are a matchmaking assistant. The user prefers outdoor activities and wants a partner in the Tokyo area. Here are the top candidate partners:
1. Candidate: Name: A, Age: 31, Location: Tokyo, Hobbies: mountain climbing, trail running, camping, Similarity score: 0.92
2. Candidate: Name: B, Age: 30, Location: Tokyo, Hobbies: hiking, jogging, Similarity score: 0.88

Choose the single best recommended partner and generate one friendly recommendation sentence in English.
Output format: ‘Your recommended partner is [Name]. [Brief reason].’”

### Step 12

The server inputs the prompt sentence into the generative AI model and obtains recommendation text expressed in natural language. The input is the prompt sentence; the output is a generated text string that follows the specified format. The server tokenizes the prompt, sends the token sequence to the generative AI model running on a hardware accelerator or via an external inference service, and receives token probabilities at each decoding step. The server applies a decoding strategy to produce the final recommendation text, which includes a selected candidate name and a brief reason consistent with the similarity scores and attributes provided in the prompt. The server may perform minimal post-processing, such as trimming whitespace or checking length, while preserving the essential content.

### Step 13

The server generates output data by associating the generated recommendation text with the identification information of the selected candidate entities and transmits the output data to the terminal. The input is the recommendation text and the refined candidate list; the output is a structured response containing text and identifiers. The server packs the recommendation text, the identifier of the top candidate, and optionally additional metadata (such as similarity score or list of alternative candidates) into a response object, serializes it into a transmittable format, and sends it over the network to the terminal. The server may also log this response for later analysis or feedback-based model improvement.

### Step 14

The terminal receives the output data from the server and presents the recommendation to the user through the display unit. The input is the serialized response object; the output is the visual display of recommendation text and associated candidate information on the terminal screen. The terminal deserializes the response, extracts the recommendation text and candidate identifier, and updates the user interface to show the text in a designated area along with selected attributes, such as the candidate's age, location, and main interests. The terminal may provide interactive controls, such as buttons to view a full profile or request another recommendation, and sends additional requests to the server when the user interacts with these controls.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented recommendation and communication support systems typically treat user input as static data and apply fixed rule-based or simple machine-learning algorithms to generate suggestions. In many such systems, a processor receives user profile information and search queries, performs a database lookup, and returns a ranked list of items. However, these systems often exhibit several technical limitations.

First, conventional systems generally do not tightly integrate multi-modal input processing, such as text and audio, into a unified, feedback-driven pipeline. Text input, if analyzed at all, is processed with shallow keyword matching, while audio input is either discarded or used only for basic speech-to-text conversion. As a result, the underlying computing architecture fails to exploit the rich information available in linguistic structure and acoustic features, and cannot accurately estimate an emotion state of the user. This leads to technically sub-optimal selection and ranking of candidate items or messages at the system level.

Second, traditional architectures do not dynamically adapt the way generative AI models are invoked. Specifically, prompt sentences sent to a generative AI model are typically static or manually designed, and do not systematically encode machine-readable meta information such as extracted keyword information, context information, estimated emotion state, and behavior history. Because of this, the generative model is under-utilized as a computing resource: the model receives incomplete context, produces generic output, and forces other components of the system to perform costly post-processing to adjust tone, content, or relevance. The absence of programmatic, data-driven prompt construction degrades overall computational efficiency and accuracy.

Third, many existing systems lack a closed feedback loop in which the processor uses user behavior history, such as acceptance or rejection of suggested content, to update generation conditions for both prompts and recommendations. Without an automated mechanism to log, aggregate, and feed back behavior history into subsequent inference steps, the system cannot improve its internal models, including its prompt generation logic and its weighting of candidate items, over time. This limits the ability of the computing system to self-optimize and to achieve more accurate and context-sensitive outputs with fewer computational resources.

Fourth, in systems that attempt to provide communication support, such as rewriting messages or suggesting dialogue, the underlying computer processes often treat emotional tone and linguistic form as separate concerns. A rewriting engine may improve grammar, while an emotion classifier runs in isolation. The absence of an integrated pipeline that jointly considers real-time emotion estimation, meta-data driven prompt generation, and coupled output formatting results in fragmented processing pathways, redundant data transformations, and increased latency in user-facing applications, particularly on resource-constrained client devices.

Accordingly, there is a need for an improved computer-implemented system in which a processor: (i) unifies text, audio, and contextual data into a structured representation; (ii) performs emotion estimation as a first-class computational step; (iii) automatically generates prompt sentences that encode meta information for a generative AI model; (iv) interprets output from the generative AI model into machine-structured recommendation and message-modification data; and (v) closes the loop by logging user behavior history and using it to update generation conditions. Such a system would improve the technical functioning of the underlying computing architecture by reducing manual configuration of generative models, increasing the relevance and personalization of automatically generated outputs, and enabling more efficient use of computing and network resources in recommendation and communication support tasks.

The specific processing by the specific processing unit 290 of the data processing device 12 in Application Example 2 is realized by the following means.

The present invention provides a server comprising a processor and one or more storage devices, the processor being configured to cause a user to input attribute information and request content via an information processing apparatus, cause the information processing apparatus to transmit text data and audio data input by the user to an information storage apparatus via a communication apparatus, perform speech recognition on the audio data to obtain character data, perform natural language processing on the character data to extract keyword information and context information, perform emotion estimation processing to estimate an emotion state of the user based on at least the character data and the audio data, search, based on the keyword information and the emotion state, for target information stored in the information storage apparatus to extract candidate information, generate, based on the candidate information, the attribute information of the user, the emotion state, and the request content, a prompt sentence for instructing an analysis or generation process by a generative AI model, input the prompt sentence to the generative AI model and obtain response information including recommendation information and/or expression-improvement information from the generative AI model, analyze the response information and format the response information as a recommendation result associated with the target information or as a modification proposal of a message that the user intends to transmit, transmit the formatted response information as presentation data to the information processing apparatus, acquire a selection operation or an acceptance result by the user with respect to the presentation data, store behavior history information including the acceptance result in the information storage apparatus, and update generation conditions of at least the prompt sentence and the recommendation result based on the behavior history information and the emotion state. This enables the computing system to implement an integrated, feedback-driven processing pipeline that dynamically encodes multi-modal analysis results into prompt sentences for the generative AI model, improves the technical accuracy and personalization of generated outputs, reduces redundant processing and manual configuration, and enhances the overall efficiency and responsiveness of recommendation and communication support functions executed by the server.

The term “user” refers to a person or entity that operates an information processing apparatus to provide input data, such as attribute information, request content, text data, or audio data, to the system.

The term “information processing apparatus” refers to an electronic device, such as a computing device or communication terminal, that provides a user interface for receiving user input and transmitting the input data to a server or information storage apparatus via a communication apparatus.

The term “communication apparatus” refers to a hardware and software component that enables data transmission between the information processing apparatus, the server, and the information storage apparatus over a communication network.

The term “information storage apparatus” refers to one or more storage devices or databases that store data used by the system, including user attribute information, request content, target information, candidate information, emotion states, behavior history information, and generated results.

The term “processor” refers to one or more hardware processing units, such as a central processing unit or other computing circuitry, configured to execute instructions for performing the functions of receiving, analyzing, generating, and transmitting data as defined in the claims.

The term “text data” refers to digital data representing characters, words, sentences, or other linguistic units input by the user or obtained by converting audio data into character data.

The term “audio data” refers to digital data representing sound, including spoken utterances by the user or by another person, captured by an input device such as a microphone.

The term “speech recognition” refers to a process executed by the processor or an external service that converts audio data representing speech into character data, thereby obtaining a textual representation of spoken content.

The term “character data” refers to text information obtained as a result of speech recognition performed on audio data, and used as an input to subsequent natural language processing and emotion estimation processing.

The term “natural language processing” refers to a set of computational techniques applied to character data to analyze linguistic structure, including operations such as tokenization, part-of-speech tagging, syntactic or semantic parsing, and extraction of keyword information and context information.

The term “keyword information” refers to one or more words, phrases, or terms extracted from character data that represent essential concepts, topics, or entities relevant to the user's request content or attribute information.

The term “context information” refers to information derived from character data that indicates a situational or semantic background of the user's input, including dialogue context, intent, domain, or other contextual attributes used to interpret the meaning of the input. The term “emotion estimation processing” refers to computational processing in which the processor analyzes one or more of character data and audio data, and optionally acoustic features, to estimate an emotion state of the user.

The term “emotion state” refers to a classification or representation of a psychological or affective condition of the user, such as joy, sadness, anxiety, calmness, excitement, or similar states, as estimated by the emotion estimation processing.

The term “acoustic features” refers to numerical values derived from audio data, such as pitch, intensity, spectral characteristics, or temporal patterns, that are used as inputs to a learned model for emotion estimation or other audio-based analysis.

The term “learned model” refers to a computational model, such as a machine learning model or neural network, that has been trained using training data to perform tasks including emotion estimation or classification of user states.

The term “target information” refers to information items stored in the information storage apparatus that are candidates for recommendation or selection, such as records representing products, services, counterpart users, content items, or communication options.

The term “candidate information” refers to a subset of target information selected by the processor based on keyword information, emotion state, and other conditions, and provided as potential options for recommendation or further analysis.

The term “attribute information” refers to data representing properties of the user, including but not limited to age range, occupation category, interest category, location category, or other profile-related characteristics.

The term “request content” refers to information input by the user that indicates a desired purpose, query, or task to be fulfilled by the system, such as a search request, recommendation request, or communication support request.

The term “generative AI model” refers to a machine learning model, such as a language generation model, configured to generate text or other content based on input data including a prompt sentence, and to output response information such as recommendation information or expression-improvement information.

The term “prompt sentence” refers to a text string generated by the processor that encodes instructions, meta information, and contextual information for the generative AI model, and that is used as an input to cause the generative AI model to perform analysis or generation processing.

The term “analysis or generation process” refers to processing executed by the generative AI model in response to a prompt sentence, including operations such as reasoning, content selection, or creation of new text representing recommendations or message variations. The term “response information” refers to data output by the generative AI model in response to a prompt sentence, including recommendation information, expression-improvement information, explanation text, or other generated content.

The term “recommendation information” refers to information within the response information that identifies one or more target information items and optionally provides reasons, rankings, or descriptions indicating why the items are recommended to the user. The term “expression-improvement information” refers to information within the response information that proposes a revised, enriched, or otherwise improved version of a message or expression that the user intends to transmit.

The term “recommendation result” refers to structured data created by the processor based on the response information, in which recommended target information items are associated with identifiers, explanations, and other metadata suitable for presentation to the user.

The term “modification proposal” refers to a proposed alternative form of a user message, derived from expression-improvement information, that is formatted for display and potential adoption by the user.

The term “presentation data” refers to data formatted by the processor for output on the information processing apparatus, including recommendation results, modification proposals, and associated text or metadata used to render a user interface.

The term “selection operation” refers to an action performed by the user via the information processing apparatus, such as choosing, confirming, rejecting, or editing one of the recommendation results or modification proposals.

The term “acceptance result” refers to information indicating whether and how the user accepted or used a recommendation result or modification proposal, including confirmation, partial acceptance, or rejection.

The term “behavior history information” refers to data representing one or more user actions over time, including selection operations, acceptance results, and other interaction events, stored in the information storage apparatus for subsequent analysis.

The term “generation conditions” refers to parameters, rules, or weighting factors used by the processor when generating a prompt sentence or forming a recommendation result, which may include references to emotion state, behavior history information, or other context. The term “meta information” refers to summarized information derived from multiple sources, including attribute information, request content, emotion state, candidate information, and behavior history information, and embedded in the prompt sentence to provide richer context to the generative AI model.

The term “dialogue message” refers to a text string suggested for use in a communication between the user and another party, generated or improved by the system based on the prompt sentence and the generative AI model output.

In one embodiment, a server implements the claimed system by executing program modules on general-purpose computer hardware. The server includes at least one central processing unit, a volatile memory, a non-volatile storage device, a network interface, and an information storage apparatus implemented as a relational database system. The server runs an operating system and an application framework, such as a web application framework written in a high-level programming language. The server deploys dedicated software components for natural language processing, speech recognition integration, emotion estimation, prompt sentence generation, generative AI model invocation, response parsing, and behavior history learning.

A terminal operates as an information processing apparatus. The terminal includes a processor, a display, an input device such as a touch panel or keyboard, an audio input device such as a microphone, and a network communication module. The terminal executes a client application, such as a web browser or a native application, that presents graphical user interfaces for the user to input attribute information and request content, and to review recommendation results or message modification proposals.

A user interacts with the terminal to supply attribute information and request content to the server. The user enters profile-related items such as an age category, a work category, an interest category, and a location category using input fields displayed on the terminal. The user further inputs request content, such as a natural language query or a draft message intended for another person. The user may also speak into the microphone so that the terminal captures audio data. The terminal encapsulates the input text data and audio data in a structured message and transmits the message to the server via a communication network. The server implements a data model in the information storage apparatus. The server stores user profiles in a user table, which includes fields for a user identifier, age category, work category, interest category, and location category. The server stores request content and raw input in an input log table, which includes fields for an input identifier, user identifier, context type, text data, audio reference, and timestamp. The server stores target information, such as records representing items to recommend, in one or more target tables with fields for a target identifier, type category, descriptive text, tags, and auxiliary attributes. The server stores emotion states in an emotion table, and stores behavior history information in an action log table, which includes selection operations and acceptance results for presented data. The server executes natural language processing on character data obtained from text input or speech recognition. The server uses a natural language processing library to perform tokenization, part-of-speech tagging, and dependency parsing. The server identifies nouns and noun phrases as candidate keyword information and extracts clause-level structures to derive context information, such as whether the input represents a search request or a message to a counterpart. The server converts the character data into a numerical representation, such as a sequence of token indices or an embedding vector, and supplies this representation to downstream models.

The server integrates a speech recognition service to obtain character data from audio data. The server transmits audio segments to an external speech recognition interface and receives transcribed text with time stamps and confidence scores. The server filters the transcribed text based on confidence thresholds and merges multiple segments into a coherent character string. The server stores the resulting character data in the input log table so that it can be reused by subsequent processing steps without repeating speech recognition.

The server executes emotion estimation processing using both text-based features and audio-based features. For the text-based part, the server applies a text classifier implemented as a neural network model. The model can be a multi-layer neural architecture such as a recurrent network, a convolutional network, or a transformer-based encoder, trained to classify emotion states such as joy, sadness, anxiety, and calmness. The server encodes character data into token embeddings, passes the embeddings through multiple hidden layers with non-linear activation functions, and applies a softmax output layer to obtain class probabilities for emotion states. For the audio-based part, the server extracts acoustic features from the audio data, such as Mel-frequency cepstral coefficients, pitch contours, and energy statistics. The server supplies these acoustic features to another neural network or merges them with text features in a joint model. The server computes an emotion state by combining the text-based and audio-based outputs, for example by weighted averaging or by a secondary classifier that receives concatenated features.

The server stores each estimated emotion state, together with a timestamp and a reference to the corresponding input, into the emotion table. The server maintains a temporal sequence of emotion states per user and computes trajectories of emotion, such as transitions from anxiety to calmness. The server may aggregate emotion sequences into features representing stability or volatility of the user's emotional behavior, which feature vectors are then used when generating prompts and adjusting recommendation conditions.

The server searches for candidate information in the information storage apparatus based on keyword information and emotion state. For example, when the keyword information indicates camping-related topics and the emotion state suggests excitement, the server constructs a database query that selects target information records whose tags include camping and whose attributes match the user's profile. The server may apply additional weighting based on emotion state, such as giving higher priority to active or high-engagement items when the user is excited. The server sorts the retrieved target information items according to a composite score computed from keyword match, profile match, popularity metrics, and emotion-dependent factors.

The server generates a prompt sentence for a generative AI model by encoding meta information into a structured natural language input. The server retrieves the user's attribute information from the user table, obtains the latest emotion state from the emotion table, and gathers candidate information from the target tables. The server composes meta information strings summarizing these elements, for example by forming a paragraph that lists key attributes and candidate item descriptions in plain text. The server then embeds this meta information into a template that specifies the requested type of output from the generative AI model.

For example, the server may generate a prompt sentence for recommending items as follows:
User input: “ [symbol] ”.
Emotion: “excited”.
User profile: age 30s, outdoor interests, beginner level.

From the following product list, select several camping products suitable for this user and explain briefly why each item is recommended.

### Product List:

1. Tent A, lightweight, 2 persons, three-season.
2. Sleeping bag B, compact, suitable for spring and autumn.
3. Lantern C, LED, long battery life.

In another case, the server may generate a prompt sentence for message enrichment as follows:

The user wants to send the following message to a partner:
“ [symbol] , [symbol] ”
Current emotion: “joy”.

Rewrite this message with richer emotional nuance and warmth, keeping the same meaning. Return only the improved message.

The server transmits the prompt sentence as input to the generative AI model. The generative AI model can be implemented as a large-scale neural language model trained on a corpus of text data. The model architecture may be a transformer-based network with multiple self-attention layers, layer normalization, and feed-forward sub-layers. The server configures generation parameters such as maximum output length, sampling temperature, and penalty terms for repeated tokens. By supplying meta information in the prompt sentence, the server directs the model to utilize context, emotion state, and candidate information in a unified manner when producing response information.

The server receives response information from the generative AI model and parses the output. When the response information is structured as a sequence of recommended items with explanations, the server separates each line or numbered entry into a candidate label and a reason phrase. The server matches the candidate labels to target information records using string similarity metrics or identifiers included in the prompt. When the response information is a modified version of a user message, the server encapsulates this text as a modification proposal. The server converts these results into presentation data, which may include identifiers, display names, and explanation text, and stores the generated content in result tables.

The server transmits the presentation data to the terminal. The terminal updates its display to show recommended items or modification proposals in a user interface. The user inspects the presentation data and performs selection operations, such as choosing one of the recommended items or accepting a proposed message. The terminal sends the user's selection or acceptance result back to the server.

The server records behavior history information in the action log table. The server associates each action with the corresponding prompt sentence, emotion state, candidate set, and resultant response information. The server uses this behavior history information to update generation conditions. For example, the server may adjust weights used in its scoring function when ranking target information, or adjust prompt templates to emphasize brevity or detail depending on the user's past preferences. The server may also retrain or fine-tune local models, such as the emotion classifier or a scoring model, by using acceptance results as labels. In this way, the server incrementally adapts its internal parameters based on observed user interactions.

The server thereby improves computing performance by reducing the number of iterations needed to achieve acceptable recommendations or message modifications. Because the server encodes emotion state, context information, and behavior history into prompt sentences, the generative AI model receives a more informative input and produces outputs that require less post-processing. This reduces computational load in downstream modules and lowers latency experienced by the user. The system also decreases network traffic between the server and the terminal, since fewer back-and-forth requests are required to refine recommendations. The server applies non-conventional processing rules that differ from simple human decision-making. For instance, the server may enforce a non-linear weighting scheme in which historical rejection of certain stylistic patterns in generated messages causes specific tokens, phrases, or tonal markers to be penalized in future prompt construction. The server can also apply constraint encoding techniques, such as inserting explicit instructions to avoid certain categories of content, to guide the generative AI model. These mechanisms result in a machine-optimized prompt generation strategy that would be difficult to emulate reliably with manual human configuration.

In an alternative embodiment, the generative AI model resides on a separate computing device or cloud resource, and the server operates as a client. The server still performs prompt sentence generation, emotion estimation, and candidate selection locally, while outsourcing only the language generation functions. The server can batch multiple prompt sentences in a single call to improve throughput and reduce network overhead when handling large numbers of concurrent users.

In another embodiment, the server supports real-time interaction on a wearable terminal such as smart glasses. In this case, the terminal continuously streams audio data to the server. The server performs low-latency emotion estimation using a reduced-complexity model and constructs shorter prompt sentences focusing on the most recent utterances. The server then generates concise response information, such as a single informative sentence, that the terminal displays on a compact screen. By optimizing the size and structure of prompt sentences and the complexity of models for this usage, the server reduces end-to-end latency and ensures that the system can operate under strict timing constraints.

In yet another embodiment, the server implements different types of generative AI models for different functions. A first model specializes in recommendation language and receives prompt sentences summarizing candidate items and user profiles; a second model specializes in conversational style adaptation and receives prompt sentences that highlight emotional context and target tone. The server selects which model to invoke based on the request content, thereby distributing computing tasks appropriately among models optimized for particular domains. This architecture improves output quality and reduces the need for large, generic models in all scenarios.

The system thereby achieves technical effects not limited to abstract information processing. By defining explicit data structures for attribute information, emotion states, candidate information, prompt sentences, and behavior history, and by orchestrating neural models and database operations in a specific sequence, the server improves the technical functioning of the computing environment. The system enables more accurate and stable emotion estimation, more context-aware and efficient use of generative AI resources, more compact network communication between server and terminal, and more adaptive behavior of recommendation and message support logic over time. These improvements are realized through particular arrangements of components and algorithms inside the server and cannot be obtained by merely performing the same high-level tasks manually or by naïve automation.

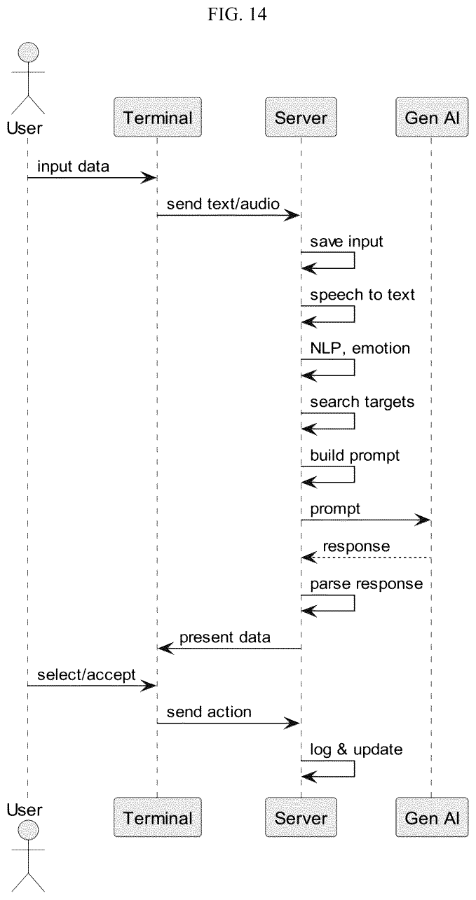

The following describes the processing flow using FIG. 14.

### Step 1

User operates the terminal to input data.

User inputs attribute information and request content via a graphical user interface on the terminal, such as profile items (age category, work category, interest category, location category), a free-form query (for example, “ [symbol] ” or “I want relaxing music”), or a draft message (for example, “ [symbol] [symbol] ”).

User optionally speaks into a microphone, and the terminal captures audio representing spoken utterances.

Input: Human actions on the terminal (key strokes, touch input, speech).

Output: Structured input data in the terminal memory, including fields such as user identifier, attribute information, request content text, and raw audio data.

Terminal converts these human inputs into internal data structures (for example, a dictionary containing profile fields and text strings) and buffers audio data frames in a recording buffer.

### Step 2

Terminal transmits input data to the server.

Terminal packages the buffered input data into a request message, attaching a user identifier, context type (for example, “recommendation_request” or “message_enrichment”), text data (if any), and audio data (if any).

Terminal sends this message to the server via a network interface using a communication protocol such as HTTPS.

Input: Local structured input data (user identifier, text data, audio data, context type).

Output: Network request packet containing the structured input data sent to the server. Terminal serializes the structured input data into a format such as JSON, encapsulates it in a transport frame, and forwards it over the network stack to the server address.

### Step 3

Server receives and stores the raw input.

Server accepts the network request, parses the incoming message, and extracts fields such as user identifier, text data, audio data, and context type.

Server writes a new record into an input log table in the information storage apparatus, associating the input with a unique input identifier and a timestamp.

Input: Network packet containing serialized input data from the terminal.

Output: Parsed input data in server memory and a persistent record in the input log table. Server deserializes the JSON payload, creates an internal object (for example, an input object with attributes for text and audio), and executes a database insertion operation using a structured query to persist the input.

### Step 4

Server performs speech recognition on audio data (when present).

Server checks whether audio data is included in the parsed input.

Server forwards the audio data to a speech recognition interface, receives recognized character data, and associates the recognized text with the corresponding input identifier.

Input: Raw audio data and the input identifier.

Output: Character data (transcribed text) stored in server memory and in the input log table. Server sends the audio payload to an external speech recognizer, receives a transcription result, filters segments with low confidence, concatenates the remaining segments, and updates the input log table record to include the final character string.

### Step 5

Server preprocesses text and extracts keyword and context information.

Server selects the latest character data for the given input identifier, using either user-provided text or recognized text.

Server tokenizes the text into word units, applies part-of-speech tagging, and identifies nouns and noun phrases.

Server detects a context type (for example, search query, recommendation request, message to partner) based on structural patterns and key verbs.

Input: Character data corresponding to the user's input and metadata such as context type.

Output: Keyword information (a set of selected words or phrases) and context information (a classification of the intent and domain).

Server runs a natural language processing routine that maps the character data to a list of tokens, tags each token with a grammatical category, groups tokens into candidate phrases, selects phrases with domain-relevant tags as keywords, and applies intent classification rules or a small classifier to label the context.

### Step 6

Server performs emotion estimation processing.

Server gathers the character data and, when available, audio-derived features such as pitch and energy.

Server encodes the text into a numerical representation and combines it with acoustic features.

Server inputs this combined feature vector into an emotion estimation model, which outputs probabilities for different emotion states and selects the most likely emotion state.

Input: Character data and, optionally, acoustic features extracted from the audio data.

Output: An emotion state label (for example, joy, sadness, anxiety, excitement) and an associated confidence score.

Server performs numerical operations to compute token embeddings, aggregates them via a neural architecture, merges them with acoustic feature vectors, applies matrix multiplications and non-linear activation functions, and computes a probability distribution over emotion classes using a softmax function; the class with the highest probability is taken as the emotion state and recorded in the emotion table.

### Step 7

Server searches target information and extracts candidate information.

Server uses the keyword information, context information, and the user's attribute information from the user table to construct search conditions.

Server queries target information tables (for example, items, content, or counterpart users) in the information storage apparatus using these conditions, optionally weighting results based on the emotion state.

Input: Keyword information, context information, emotion state, and user attribute information.

Output: Candidate information, which is a list of target records that satisfy the search conditions and are scored for relevance.

Server executes structured database queries that filter by tags or fields matching the keywords, apply range filters based on user attributes, compute a composite score for each record using arithmetic operations on popularity metrics and emotion-dependent weight factors, and returns a ranked list of candidate records.

### Step 8

Server generates a prompt sentence for a generative AI model.

Server retrieves the user's attribute information and the latest emotion state from the storage apparatus, and aggregates descriptions of the candidate information into a compact text list. Server constructs a meta information section that summarizes the user's profile, emotion, request content, and candidate descriptions.

Server embeds this meta information into a template to form a prompt sentence tailored to the current context (for example, recommendation, message enrichment, or dialogue support).

Input: User attribute information, request content, emotion state, and candidate information.

Output: A prompt sentence in natural language that encodes instructions and meta information for the generative AI model.

Server concatenates text fragments with formatting markers (such as numbered lists), ensures that the prompt includes explicit instructions (for example, “select several items and explain why”), and produces a single text string ready for submission to the generative AI model.

### Step 9

Server invokes the generative AI model and obtains response information.

Server sends the prompt sentence to the generative AI model interface with generation parameters such as maximum output length and randomness level.

Server receives generated text that contains recommendation information and/or expression-improvement information according to the instructions given in the prompt sentence.

Input: Prompt sentence and generation parameters.

Output: Response information from the generative AI model in the form of generated text. Server transmits the prompt as input to the model, waits for the model to execute internal numerical computations (such as attention operations and token probability calculations), receives a sequence of output tokens, decodes the tokens into text, and stores the resulting text in an intermediate buffer.

### Step 10

Server parses response information and constructs presentation data.

Server splits the generated text according to its expected structure, such as numbered lines for recommendation entries or a single block of text for a modified message.

Server identifies references to candidate items by matching names or identifiers and associates each recommended item with its explanation.

Server formats message modifications into a structure suitable for editing, such as a single revised sentence.

Input: Response information in text form and the original candidate information.

Output: Presentation data comprising a structured recommendation result or a modification proposal annotated with identifiers and explanation text.

Server applies string processing routines to identify separators, maps labels from the generated text back to stored target identifiers, constructs data records that pair target identifiers with generated reason phrases, and encapsulates these records into a response object ready to be serialized for the terminal.

### Step 11

Server records behavior history and updates generation conditions.

Server receives follow-up data from the terminal indicating which recommendations or modification proposals the user has selected, accepted, or rejected.

Server writes these actions into an action log table, linking each action to the corresponding input, candidate set, prompt sentence, emotion state, and response information.

Server computes updated generation conditions, such as adjusting internal weights or modifying future prompt templates, based on patterns in the recorded behavior history.

Input: User selection operations and acceptance results, together with references to earlier processing artifacts.

Output: Updated behavior history information in the storage apparatus and modified generation conditions stored in configuration or model parameters.

Server executes database insertions to log each action event, runs analysis routines that aggregate acceptance rates for different styles of output, performs arithmetic updates to parameters (for example, increasing weights for previously successful prompt structures), and stores the revised parameters in configuration tables or in model weight files.

### Step 12

Server transmits presentation data to the terminal, and terminal displays it to the user.

Server serializes the presentation data into a response message, attaches necessary metadata such as display labels, and sends the message back to the terminal via the communication apparatus.

Terminal receives the response, parses the structured data, and updates the user interface to show recommended items with explanations or a proposed revised message in an editable text field.

Input: Presentation data in server memory (structured recommendation result or modification proposal).

Output: Displayed content on the terminal screen and interactive elements allowing the user to act on the presented options.

Server converts the data structure to a serialized format and transmits it; terminal deserializes the data, maps the items to interface components, renders text and images on the display, and attaches event handlers so that user interactions are captured and can be sent back to the server in subsequent cycles.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

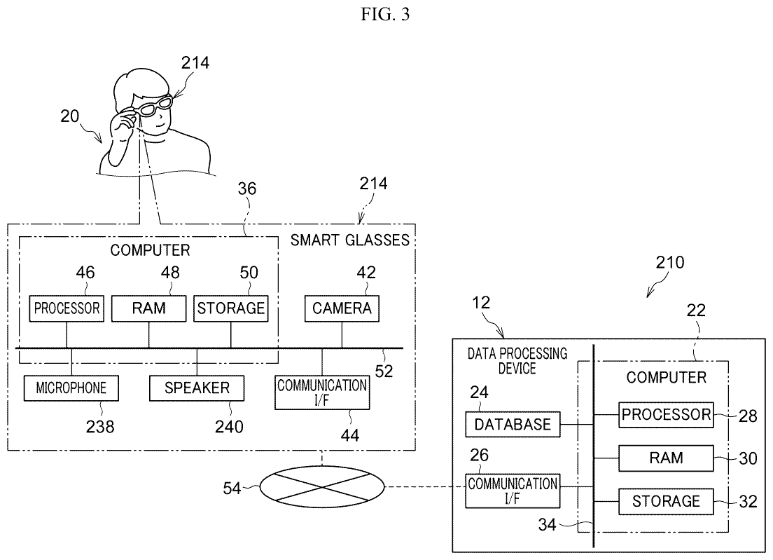

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

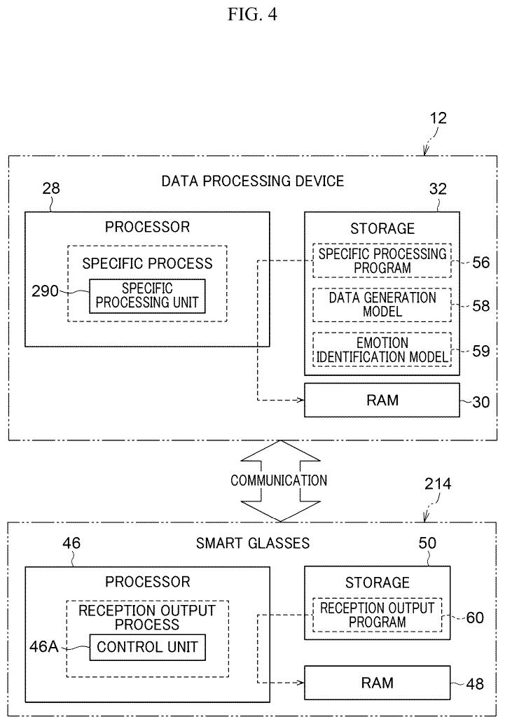

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

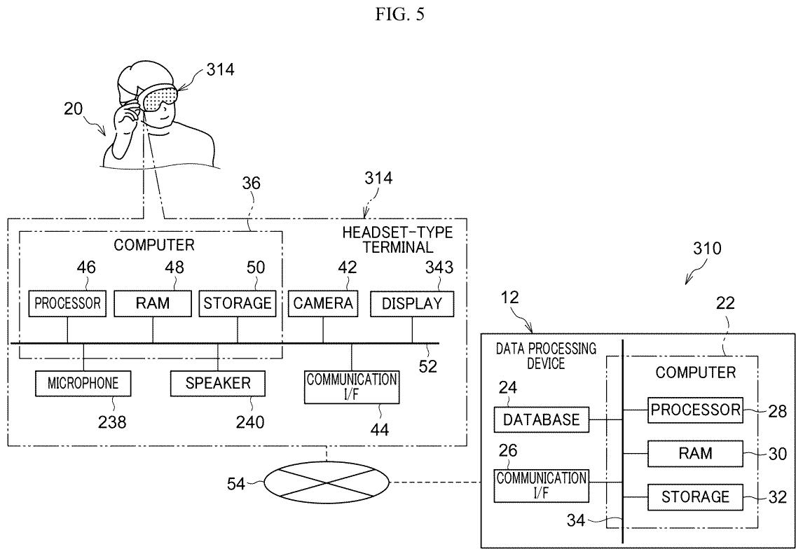

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

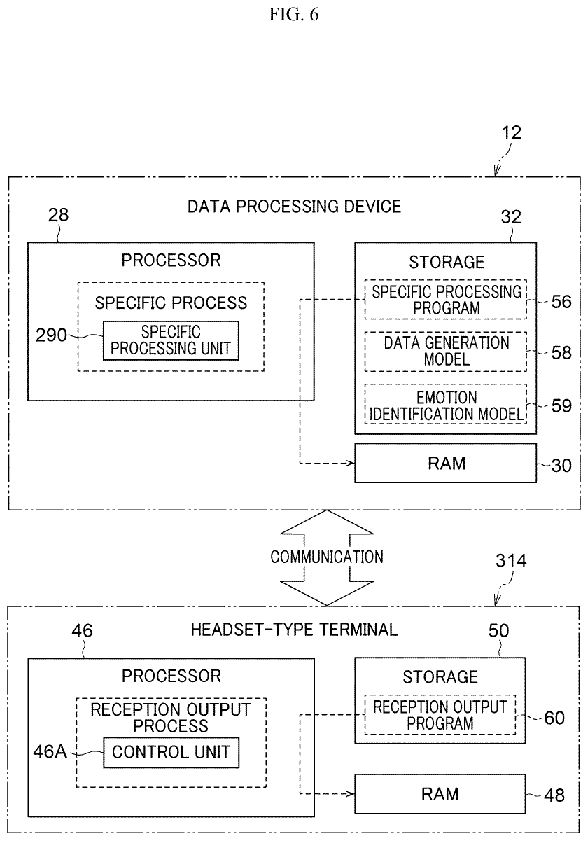

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

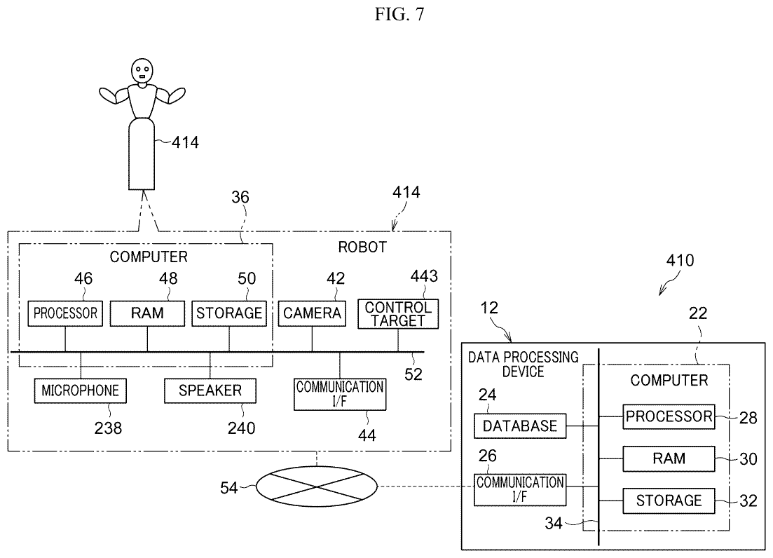

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

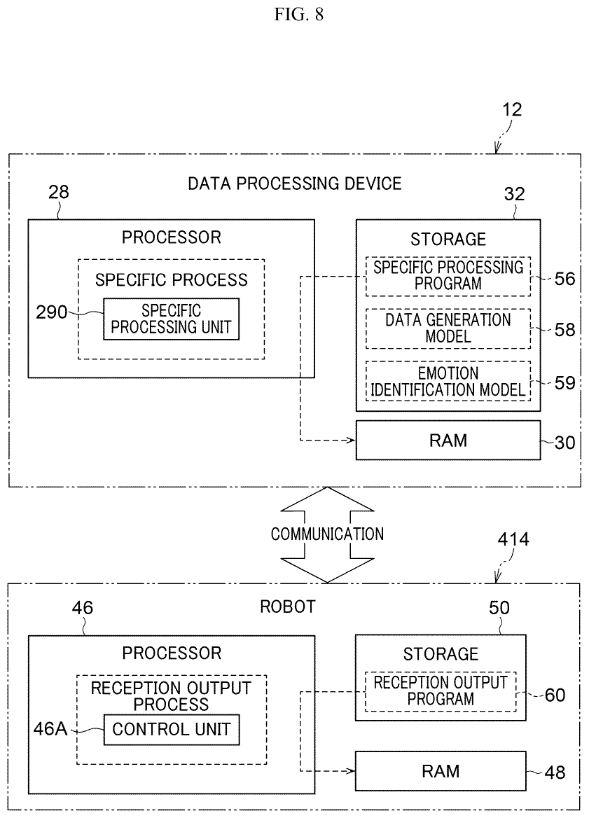

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

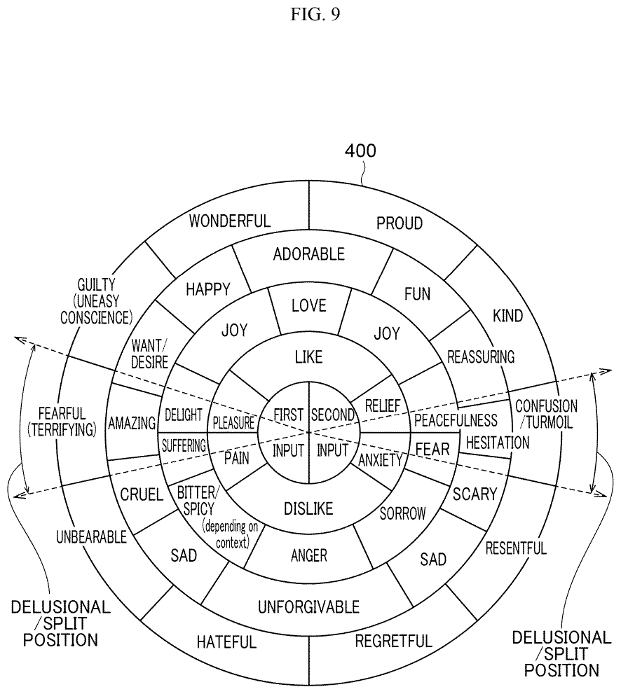

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

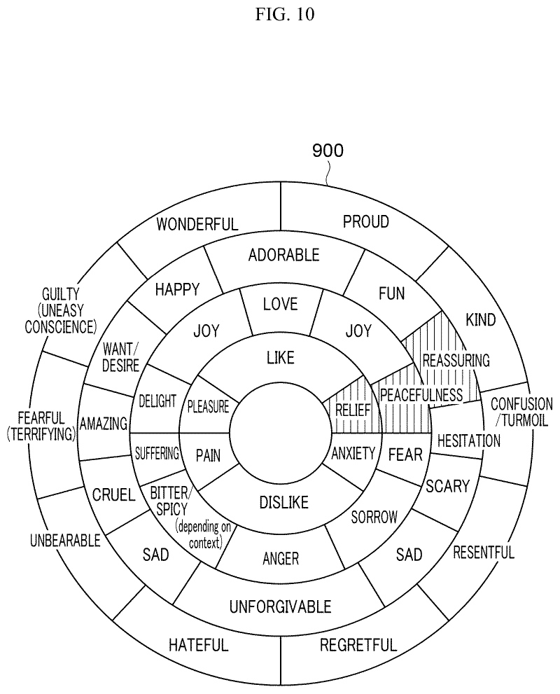

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
cause a terminal device to provide, via a display control unit, a screen interface through which a user inputs attribute conditions and preference information regarding a desired target, cause the terminal device to transmit the input attribute conditions and the preference information to a server device through a communication device using an encrypted communication scheme,
cause the server device to store user information including the attribute conditions and the preference information in an information storage device including a relational database device, and to acquire the user information and other user information accumulated in the information storage device,
cause the server device to perform preprocessing on the acquired user information and the other user information by a data conversion unit to generate numerical feature data and character string feature data,
cause the server device to generate a prompt sentence including a natural language expression corresponding to the attribute conditions and the preference information and configured based on the numerical feature data and the character string feature data, and to input the prompt sentence into a generative AI model so as to instruct an analysis process,
cause the generative AI model to execute machine learning processing including similarity calculation between feature vectors based on the prompt sentence and the numerical feature data and the character string feature data, to identify target candidates suitable for the user's preference, and to output evaluation information for the target candidates,
cause the server device to rank the target candidates based on the evaluation information to generate recommendation result data to be presented to the user, and
cause the terminal device to receive the recommendation result data and to generate and present a display screen including attribute information of the target candidates and the evaluation information to the user.

### Supplementary 2

The system according to supplementary 1,
wherein the processor is configured to cause the server device to acquire behavior history information of the user from the information storage device, to update components of the prompt sentence and weighting of the numerical feature data and the character string feature data based on the behavior history information, and to perform re-analysis by the generative AI model using the updated prompt sentence and feature data so as to sequentially update the recommendation result data for the target candidates.

### Supplementary 3

The system according to supplementary 1,
wherein the processor is configured to cause the server device to execute, on the target candidates and the evaluation information output from the generative AI model, a filtering process and a score correction process based on a rule set including a location condition, a contact history condition, and an exclusion condition, and to generate the recommendation result data by finally selecting the target candidates based on results of the filtering process and the score correction process.

### Application Example 1

### Supplementary 1

A system comprising a processor,
wherein the processor is configured to
receive, from a user terminal, attribute information and preference information of a user via a user interface of the user terminal, and acquire the attribute information and the preference information input by the user through the user terminal,
store, via a communication device, the received attribute information and preference information as profile information in an information storage medium, and acquire profile information of other users different from the user from the information storage medium, generate a prompt sentence for a generative AI model based on the preference information of the user and the profile information of the other users, the prompt sentence including the preference information of the user and a plurality of profile information items of the other users, input the prompt sentence into the generative AI model, and cause the generative AI model to perform analysis to generate matching candidates based on a correspondence between the preference information of the user and the profile information of the other users, analyze an output of the generative AI model corresponding to the matching candidates, and generate recommendation information including identification information for identifying each of the other users, profile information of each of the other users, evaluation information included in the matching candidates, and reason information generated by the generative AI model,
transmit the recommendation information to the user terminal and cause the user terminal to present, in real time, candidates of the other users to the user,
receive, from the user terminal, identification information of another user selected by the user based on the recommendation information and communication text information input by the user, generate a prompt sentence into which the communication text information is inserted, input the prompt sentence into the generative AI model, and cause the generative AI model to perform a communication support process including text improvement or proposal of alternative expressions, and
transmit improved communication text information obtained as a result of the communication support process to the user terminal, and record, as a message between users, at least one of the improved communication text information and a transmission text based on the improved communication text information, and relay the message between a plurality of user terminals.

### Supplementary 2

The system according to supplementary 1,
wherein the processor is configured to
handle the attribute information and the preference information as including at least user age information, occupation information, interest information, residential area information, business field information, skill information, and desired counterpart experience field information, and integrate the attribute information and the preference information into the prompt sentence as at least one of natural language expression and structured data to be input to the generative AI model.

### Supplementary 3

The system according to supplementary 1,
wherein the processor is configured to
update preference information of each user based on the matching candidates output from the generative AI model and history information of the communication support process, generate a new prompt sentence including the updated preference information, and input the new prompt sentence into the generative AI model so as to sequentially optimize the matching candidates and the communication support process.

### Example 2

### Supplementary 1

A system comprising a processor,
wherein the processor is configured to
receive, from a terminal, user input including desired conditions and characteristics of a target entity, the terminal being configured to transmit the user input to the processor via a communication device,
analyze, by a natural language processing algorithm, text information included in the user input to extract expressions and feature information, and generate a preference model of the user as structured data based on an extraction result, and refer to a data structure stored in an information storage device to hierarchically expand the preference model,
generate, based on the expanded preference model, a query command for an information storage device in which attribute information of candidate entities is stored, and retrieve candidate entities in accordance with a correspondence between the preference model and the candidate entities,
convert attribute information of the retrieved candidate entities and the preference model of the user into numerical feature values, apply a similarity computation algorithm based on the numerical feature values to calculate a similarity score indicating a degree of suitability of each candidate entity with respect to a preference of the user, and select the candidate entities based on the similarity score,
integrate analysis information including the preference model of the user, attribute information of the selected candidate entities, and the similarity score into text data, generate a prompt sentence including the analysis information, input the prompt sentence into a generative AI model, and cause the generative AI model to generate a recommendation text expressed in natural language, and
generate output data in which the recommendation text output from the generative AI model is associated with identification information of the selected candidate entities, transmit the output data to the terminal, and cause the terminal to present the output data by screen display.

### Supplementary 2

The system according to supplementary 1,
wherein the processor is configured to
normalize, by the natural language processing algorithm, the extracted expressions into upper-level categories including attribute categories and location categories, generate the preference model by integrating the normalized categories with behavior history information and past input history information, and perform a preference deepening process by referring to a relatedness table stored in the information storage device to add related tags to the preference model.

### Supplementary 3

The system according to supplementary 1,
wherein the processor is configured to
construct the prompt sentence input to the generative AI model by including summary information of the preference model of the user and attribute information of the candidate entities whose similarity score is equal to or greater than a predetermined threshold, and by adding control text that specifies an output format and an output style as control information, and input the prompt sentence to the generative AI model to cause the generative AI model to generate the recommendation text to be presented to the user.

### Application Example 2

### Supplementary 1

A system comprising a processor,
wherein the processor is configured to
cause a user to input attribute information and request content via an information processing apparatus,
cause the information processing apparatus to transmit text data and audio data input by the user to an information storage apparatus via a communication apparatus, and perform speech recognition on the audio data to obtain character data,
perform natural language processing on the character data to extract keyword information and context information, and perform emotion estimation processing to estimate an emotion state of the user based on the character data and the audio data,
search, based on the keyword information and the emotion state, for target information stored in the information storage apparatus, and extract candidate information,
generate, based on the candidate information, the attribute information of the user, the emotion state, and the request content, a prompt sentence for instructing an analysis or generation process by a generative AI model,
input the prompt sentence to the generative AI model and obtain response information including recommendation information or expression-improvement information from the generative AI model,
analyze the response information and format the response information as a recommendation result associated with the target information or as a modification proposal of a message that the user intends to transmit, and transmit the formatted response information as presentation data to the information processing apparatus, and
acquire a selection operation or an acceptance result by the user with respect to the presentation data, store behavior history information including the acceptance result in the information storage apparatus, and update generation conditions of the prompt sentence and the recommendation result based on the behavior history information and the emotion state.

### Supplementary 2

The system according to supplementary 1,
wherein the processor is configured to
perform the emotion estimation processing by applying a natural language processing algorithm to the character data, extracting acoustic features from the audio data, inputting the character data and the acoustic features to a learned model to estimate the emotion state, store a temporal change of the estimated emotion state as a history in the information storage apparatus, and adjust contents of the recommendation information or the expression-improvement information based on the temporal change.

### Supplementary 3

The system according to supplementary 1,
wherein the processor is configured to
generate the prompt sentence as text including meta information summarizing the attribute information of the user, the request content, the emotion state, the candidate information, and the behavior history information, and cause the generative AI model to generate, based on the prompt sentence, both a recommendation reason for target information suitable for a preference of the user and the emotion state and a candidate dialogue message for communication.

What is claimed is:

1. A system comprising:
circuitry configured to:
receive, via a communication interface coupled to a packet-switched network, from a terminal device, attribute data and preference data of a user;
store the attribute data and the preference data in a storage device;
acquire, from the storage device, profile data of a plurality of other entities;
generate, based on the preference data and the profile data, a prompt sentence for instructing a generative neural network model to perform an analysis and identify candidate entities corresponding to the preference data;
input the prompt sentence to the generative neural network model to acquire analysis result data comprising evaluation information for the candidate entities;
generate recommendation result data by ranking the candidate entities based on the evaluation information; and
transmit the recommendation result data to the terminal device via the communication interface for presentation on the terminal device.

2. The system according to claim 1, wherein the circuitry is further configured to perform preprocessing on the attribute data and the profile data by a data conversion process to generate numerical feature data and character string feature data.

3. The system according to claim 2, wherein the circuitry is configured to convert the numerical feature data and the character string feature data into feature vectors, and to execute a similarity calculation between the feature vectors to compute a similarity score for each of the plurality of other entities with respect to the preference data of the user.

4. The system according to claim 3, wherein the circuitry is configured to select, as the candidate entities, entities for which the similarity score is equal to or greater than a predetermined threshold, and to integrate the similarity score and attribute information of the selected candidate entities into the prompt sentence for input to the generative neural network model.

5. The system according to claim 1, wherein the circuitry is further configured to analyze, by a natural language processing algorithm, text information included in the preference data to extract expressions and feature information, and to generate a preference model of the user as structured data based on an extraction result.

6. The system according to claim 5, wherein the circuitry is configured to normalize the extracted expressions into upper-level categories including attribute categories and location categories, and to perform a preference deepening process by referring to a relatedness table stored in the storage device to add related tags to the preference model.

7. The system according to claim 6, wherein the circuitry is configured to generate a query command based on the preference model, retrieve candidate entities from the storage device in accordance with the query command, and incorporate attribute information of the retrieved candidate entities and the preference model into the prompt sentence.

8. The system according to claim 7, wherein the circuitry is configured to construct the prompt sentence by including summary information of the preference model and attribute information of the candidate entities whose similarity score is equal to or greater than a predetermined threshold, and to instruct the generative neural network model to generate a recommendation text in natural language expressing reasons for the recommendation.

9. The system according to claim 1, wherein the circuitry is further configured to receive, from the terminal device via the communication interface, selection data indicating a selection by the user of at least one of the candidate entities from the recommendation result data, and to store the selection data as behavior history information in the storage device.

10. The system according to claim 9, wherein the circuitry is configured to update the preference data based on the behavior history information and to generate a new prompt sentence including the updated preference data for input to the generative neural network model to sequentially optimize the recommendation result data.

11. The system according to claim 10, wherein the circuitry is configured to update weighting of the numerical feature data and the character string feature data based on the behavior history information, and to re-execute the similarity calculation using the updated weighting to generate updated recommendation result data.

12. The system according to claim 1, wherein the circuitry is further configured to receive, from the terminal device via the communication interface, identification information of a selected entity and communication text data input by the user.

13. The system according to claim 12, wherein the circuitry is configured to generate a second prompt sentence into which the communication text data is inserted, input the second prompt sentence to the generative neural network model, and cause the generative neural network model to perform a communication support process comprising at least one of text improvement and proposal of alternative expressions.

14. The system according to claim 13, wherein the circuitry is configured to transmit improved communication text data obtained from the communication support process to the terminal device, and to relay a message based on the improved communication text data between a plurality of terminal devices via the communication interface and the packet-switched network.

15. The system according to claim 1, wherein the circuitry is further configured to execute, on the candidate entities and the evaluation information, a filtering process based on a rule set including at least one of a location condition, a contact history condition, and an exclusion condition.

16. The system according to claim 15, wherein the circuitry is configured to execute a score correction process on the candidate entities based on the rule set, and to generate the recommendation result data by selecting the candidate entities based on results of the filtering process and the score correction process.

17. The system according to claim 4, wherein the attribute data comprises at least age information, occupation information, interest information, and residential area information of the user, wherein the plurality of other entities comprise other users registered in a matching service, and wherein the recommendation result data comprises partner recommendation information identifying the other users as potential matching partners together with compatibility reasons generated by the generative neural network model.

18. A system comprising:
circuitry configured to:
receive, via a communication interface coupled to a packet-switched network, from a terminal device, attribute data and preference data of a user;
store the attribute data and the preference data in a storage device;
acquire, from the storage device, profile data of a plurality of other entities;
perform preprocessing on the attribute data and the profile data to generate numerical feature data and character string feature data;
convert the numerical feature data and the character string feature data into feature vectors and execute a similarity calculation to compute a similarity score for each of the plurality of other entities;
select candidate entities for which the similarity score satisfies a predetermined threshold;
generate, based on the preference data, the similarity score, and attribute information of the candidate entities, a prompt sentence for instructing a generative neural network model to generate evaluation information and a recommendation text in natural language;
input the prompt sentence to the generative neural network model to acquire analysis result data;
generate recommendation result data by ranking the candidate entities based on the analysis result data;
transmit the recommendation result data to the terminal device via the communication interface;
receive, from the terminal device, selection data indicating a selection by the user; and
store the selection data as behavior history information and update the preference data based on the behavior history information for subsequent prompt sentence generation.

19. The system according to claim 18, wherein the circuitry is further configured to receive communication text data from the terminal device, generate a second prompt sentence including the communication text data, input the second prompt sentence to the generative neural network model to acquire improved communication text data, and relay the improved communication text data between a plurality of terminal devices via the communication interface and the packet-switched network.

20. A method performed by circuitry, the method comprising:
receiving, via a communication interface coupled to a packet-switched network, from a terminal device, attribute data and preference data of a user;
storing the attribute data and the preference data in a storage device;
acquiring, from the storage device, profile data of a plurality of other entities;
generating, based on the preference data and the profile data, a prompt sentence for instructing a generative neural network model to perform an analysis and identify candidate entities corresponding to the preference data;
inputting the prompt sentence to the generative neural network model to acquire analysis result data comprising evaluation information for the candidate entities;
generating recommendation result data by ranking the candidate entities based on the evaluation information; and
transmitting the recommendation result data to the terminal device via the communication interface for presentation on the terminal device.
